(19) United States
(12) Patent Application Publication
(10) Pub. No.: US 2021/0217321 A1
(43) Pub. Date: Jul. 15, 2021

(54) NOVEL SYSTEM AND METHOD FOR IMPROVING SAFETY WHEN OPERATING AIRCRAFT IN REDUCED- OR MODIFIED-VISIBILITY CONDITIONS

(71) Applicant: AT Systems, LLC, Carrollton, TX (US)

(72) Inventors: Andre Gilles Lavallee, Lewisville, TX (US); Steven Tyson Phillips, Owasso, OK (US)

(73) Assignee: AT Systems, LLC, Carrollton, TX (US)

(21) Appl. No.: 17/215,078

(22) Filed: Mar. 29, 2021

Related U.S. Application Data
(63) Continuation-in-part of application No. 16/125,842, filed on Sep. 10, 2018, now Pat. No. 10,971,027.
Application No. 16/125,842 is a continuation-in-part of application No. 15/367,816, filed on Dec. 2, 2016, now Pat. No. 10,249,208.

(51) Int. Cl. G08G 5/00; G06K 9/00; G09B 19/16; B64D 43/00

(52) U.S. Cl. CPC G08G 5/0091; G06K 9/0063; G09B 19/165; B64D 43/00; G06K 9/00771; G08G 5/003; G08G 5/006

(57) ABSTRACT

A system and method for improving safety when operating an aircraft in reduced or modified visibility conditions is disclosed. The system includes optical material having an electrically controllable optical state, one or more sensors to monitor flight parameters (aircraft, pilot, or environmental), and a processing circuit capable of collecting the sensor data and using it to generate electrical signals to establish the optical state of the material. The method includes using a sensor to monitor fight parameters and using the sensor information to modify a sequence of electrical signals that are used to control an optical state of an optical material having an electrically controllable optical state.

### CROSS-REFERENCE TO RELATED APPLICATIONS

This application is a continuation-in-part of U.S. patent application Ser. No. 16/125,842, filed on Sep. 10, 2018, which is a continuation-in-part of U.S. patent application Ser. No. 15/367,816, filed on Dec. 2, 2016.

### BACKGROUND

This invention generally pertains to systems and methods for training pilots to fly in sudden-onset reduced-visibility conditions (conditions with flight visibility of 5 miles or less, such as Degraded Visual Environments (“DVE”), unexpected departure from Visual Metrological Conditions (“VMC”), entry into Inadvertent Instrument Meteorological Conditions (“IIMC”)). More specifically, the invention pertains to systems and methods that incorporate electrical control of the transparency of lens material to manually or automatically selectively occlude a pilot's vision to simulate the sudden onset of a reduced visibility environment.

The use of devices to restrict a pilot's vision to simulate reduced-visibility conditions for fly-by-instrument training is well known. Typically, the condition is simulated either by (1) using a device, such as glasses, a hood, or a visor, to restrict the pilot's view during a training flight or (2) controlling the visual environment in a flight simulator. Where the prior-art fails, however, is in providing a realistic simulation of an unexpected entry into a reduced-visibility environment, such as IIMC.

Improper pilot reaction to sudden-onset reduced visibility conditions results in significant loss of life, property, and business every year. Pilots, including specifically helicopter pilots, continue to unexpectedly enter reduced-visibility conditions. These events cause spatial disorientation and loss of aircraft control. These events often result in accidents, 70% of which are fatal. According to the National Transportation and Safety Board accident data, there were over 80 civilian helicopter accidents involving IIMC, with a 70% fatality rate and another 19% injury rate, in the time period between 2000 and 2014. Overall, 89% of the accidents involving IIMC result in injuries or fatalities. See National Transportation and Safety Board, Aviation Accident Database and Synopses, available at http://www.ntsb.gov/_layouts/ntsb.aviation/index.aspx. Based on the Department of Transportation's Guidance on Treatment of the Economic Value of a Statistical Life —2015 Adjustment, these accidents had a human cost of over $1.4 billion. See https://www.transportation.gov/sites/dot.gov/files/docs/VSL2015_0.pdf. This number does not include the related damage to property and equipment or lost revenue to business. The value of property, equipment, and business that was lost or harmed due to pilot response to the sudden onset of reduced-visibility conditions could exceed the $1.4 billion mark.

The accidents in sudden-onset reduced-visibility conditions are due in large part to the flawed procedures and technological limitations of pilot training. In the National Transportation and Safety Board's 2015 Most Wanted List of Transportation Safety Improvements report, enhanced public helicopter safety was a key issue. http://www.ntsb.gov/safety/mwl/Pages/mw13_2015.aspx. Included in the report's recommendations were developing and implementing best practices for training flight crews for inadvertent flight into IMC conditions. The report also stated that training should be scenario-based. Unfortunately, there currently is no way to provide scenario-based training for Inadvertent IMC in an actual aircraft.

Currently there is no technology to simulate sudden-onset reduced-visibility conditions that provides the confusion, panic, disorientation and overall stress that comes when the visual environment is lost unexpectedly during flight. Research shows that surviving the first two minutes of the sudden-onset reduced-visibility event increases the survival rate significantly. This is the moment when the mental impact of the event is greatest. Current training techniques and equipment fail to prepare pilots to handle a sudden-onset reduced-visibility event because they fail to simulate the impact of the event on the pilot.

The most accepted technology for training pilots for sudden-onset reduced-visibility events, a flight simulator, does not properly prepare pilots for the actual event. This simulator training fails for a variety of reasons, including limited availability of simulator training, the simulator's failure to simulate the stress of an actual event, and the simulator's inability to simulate the spatial disorientation experienced in an actual event. Many pilots are rarely—if ever—able to use a simulator. And those pilots who have access to a simulator (typically commercial or military pilots) can use it at most a few times a year. Simulators do not effectively reproduce the stress of flying an actual aircraft where human life is at risk. This stress is an overwhelming factor in decision making during a true emergency. Perhaps most importantly—it is practically impossible to simulate spatial disorientation with a flight simulator. The signals the proprioceptive and vestibular systems send to the pilot's brain when the visual references are lost dictate how a pilot interprets an aircraft's attitude. Spatial disorientation is the leading cause of loss of control and is the single most important aspect that needs to be trained. The fact that most flight simulators today are non-motion simulators exacerbates the problem. Simply, these flight simulators do not accurately simulate a real-life sudden-onset reduced-visibility event.

Vision-restricting fly-by-instrument-training devices do not simulate the unexpected loss of the visual environment that leads to the stress and spatial disorientation of a sudden-onset reduced-visibility event. Because of this failing, aircraft (especially helicopters) continue to crash. People continue to die.

For example, U.S. Pat. No. 2,572,656 (“Ortenburger”) discloses a device comprising two filters, either alone transparent but that together are opaque. The device is situated on the pilot such that when viewing the horizon and flight path of the aircraft, the pilot looks through both filters and when viewing instruments in the aircraft, the pilot looks through only a single filter. Thus, the pilot is able to view the instruments but is unable to see outside the aircraft. But the pilot using the Ortenburger device knows that his visibility will be reduced by using the device. That is, the Ortenburger device, while it simulates reduced-visibility conditions, does not simulate unexpected entry into such conditions. Another vision-limiting device is disclosed in U.S. Pat. No. 2,694,263 (“Francis et al.”). Like the Ortenburger device, the Francis et al. device is situated on the pilot to reduce visibility in certain directions. The Francis et al. device is generally opaque with transparent sections that allow the pilot to see the instruments or the horizon, but not both at once. But like the Ortenburger device, the Francis et al. device cannot replicate the disorientation that comes with unexpected entry into reduced visibility conditions because the pilot dons the device knowing that it will restrict her vision.

The vision limiting device disclosed in U.S. Pat. No. 4,021,935 (“Witt I”) uses an electronically controlled LCD lens to limit a pilot's visibility based on the direction the pilot is looking. The Witt I device determines the pilot's viewing direction by measuring the incident light on the device using a directed photocell. When the pilot looks at the aircraft's instruments, the photocell registers a low level of light and the lens is kept transparent. When the pilot looks to the horizon, the photocell registers a high level of light and the lens is made opaque. A similar device is disclosed in U.S. Pat. No. 4,152,846 (“Witt II”). The Witt II device uses multiple light sensors to better determine the pilot's viewing direction. The Witt I and Witt II devices cannot replicate the disorientation that comes with unexpected entry into reduced visibility conditions because the pilot dons the device knowing that it will restrict her vision when she looks at other than the instruments.

Another approach to reduced-visibility flight training is disclosed in U.S. Pat. No. 4,698,022 (“Gilson”). The Gilson device restricts the pilot's vision by placing a translucent material over glasses except for that portion of the glasses through which the pilot views the instruments. This reduces the pilot's vision other than to a narrow field designed to allow viewing of the aircraft instruments. The degree of translucency can be varied to simulate different visibility conditions by selecting different overlay materials. But the Gilson device fails to provide a mechanism to simulate unexpected entry into reduced visibility conditions because the pilot dons the device knowing that it will restrict her vision except for a narrow field.

Yet another approach to simulating reduced visibility conditions for pilots is disclosed in U.S. Patent Application Publication No. 2012/0156655 (“Goldberg”). The Goldberg device is a combination of a transparent polarized material to cover the windows of the cockpit and another transparent polarized material to cover the lens of a viewing shield such as glasses worn by the pilot. The window polarization is orthogonal to the lens polarization such that when the pilot dons the polarized viewing shield, he cannot see through the polarized windows. As with the previously described prior-art approaches, the Goldberg device fails to provide a mechanism to simulate unexpected entry into reduced visibility conditions because the pilot dons the device knowing that he will not be able to see outside the aircraft.

The prior-art approaches to simulating reduced-visibility conditions fail in at least one important way. They do not accurately simulate the confusion, panic, disorientation, proprioceptive, and vestibular sensations that come from unplanned entry into such conditions. That is, a pilot reacts differently to inadvertent entry into a reduced-visibility condition than she does to planned entry into such a condition. And this difference may leave the pilot unprepared for reality, regardless of her training, and reduce her ability to properly react in such conditions. Improper reaction to unexpected reduced-visibility conditions may lead to fatalities, injury, and property damage. The prior-art approaches do not adequately simulate inadvertent entry into reduced-visibility conditions.

Accordingly, there is a need for a system and method for safely enabling pilots to properly handle sudden-onset reduced-visibility events.

### SUMMARY

In one aspect of the invention, a method for training a pilot to operate an aircraft in sudden onset reduced visibility includes providing an optical material with an electrically controllable visibility setting and controlling that setting with a sequence of electrical signals. For example, the optical material may include an electrooptic material with a visibility setting corresponding to the optical transmittance of the material. This transmittance may be controlled with electrical voltage or current values provided by a power supply. Similarly, the optical material may include a synthetic-vision or enhanced-flight-vision display with a visibility setting corresponding a synthesized optical transmittance. For example, the view on the display may be partially of fully occluded by processor generation of an occluding overlay. Control of the optical material is based on a predetermined or dynamically generated sequence of visibility settings. For example, visibility values corresponding to a hypothetical reduced-visibility event, such as flying into smoke or fog, may be stored in computer memory and used to generate electrical signals to control the optical state of the optical material. Similarly, the readings of a flight-safety sensor (one that senses parameters of the aircraft, pilot, or surrounding conditions) may be used to generate the visibility settings, and the associated electrical signals used to control the optical state. A flight-safety sensor is monitored and its readings are used to selectively modify the electrical signals generated based on the visibility settings to, e.g., selectively maintain, increase, or decrease the level to which the pilot's vision of his surroundings is obscured in order to address training efficacy or safety issues.

In another aspect of the invention, a system for training a pilot to operate an aircraft in the sudden onset of reduced visibility includes an electrically controllable optical material, a flight-safety sensor, computer memory, and a processing circuit that can collect and use information in the computer memory and readings from the sensor to generate electrical signals to control the optical state of the optical material. For example, the computer memory may include a preconfigured visibility-versus-time profile designed to simulate a reduced-visibility event to be used in a training session and the flight-safety sensor may be a blood-pressure sensor monitoring the pilot during the training session. The preconfigured profile may be used to control the optical state of the material subject to the sensor readings. For example, if the pilot's blood pressure rises beyond a certain point, the optical state may be set to return the pilot's vision of his surroundings to a normal state. Similarly, if the pilot's blood pressure does not indicate the induced state of spatial disorientation desired for the training session, the optical state may be set to further occlude the pilot's view of his surroundings in order to induce (or further induce) spatial disorientation.

In another aspect of the invention, a system for training a pilot to operate an aircraft in the sudden onset of reduced visibility includes an electrically controllable optical material, at least two flight-safety sensors, and a processing circuit that can collect and use readings from the two sensors to generate electrical signals to control the optical state of the optical material.

### BRIEF DESCRIPTION OF THE SEVERAL VIEWS OF THE DRAWING

These and other features, aspects, and advantages of the present invention will be become better understood with reference to the following description, appended claims, and accompanying drawings where:

FIGS. 1A-1E illustrate various approaches to electrically controlled optical material (electrooptic material, some variants referred to as “switchable glass” or “smart windows”).

FIGS. 2A and 2B illustrate an exemplary embodiment of a vision-limiting device according to the invention.

FIG. 2C illustrates an exemplary embodiment of a vision-limiting device according to the invention.

FIG. 3 illustrates an exemplary embodiment of a vision-limiting device according to the invention as disposed within the cockpit of an aircraft and as viewed from the pilot's perspective.

FIGS. 4-7 illustrate exemplary flows for training a pilot to handle a sudden-onset reduced-visibility event.

FIGS. 8-10 illustrate exemplary flows for setting a power-supply/control unit.

FIG. 11 illustrates an exemplary power supply/control unit.

FIGS. 12A-12F illustrate various views of an exemplary embodiment of a vision-limiting device according to the invention.

FIGS. 13-14 illustrate an exemplary hinge mount for mounting a vision-limiting visor to a flight helmet.

FIGS. 15A-15G illustrate an exemplary hinge mount for mounting a vision-limiting visor to a flight helmet.

FIGS. 16-17 illustrate exemplary flows for training a pilot to handle a sudden-onset reduced-visibility event with an electromechanically controllable vision-limiting device.

FIGS. 18A-18C illustrate exemplary visibility-versus-time profiles corresponding to simulated reduced-visibility events.

FIGS. 19A-19C illustrate exemplary visibility-versus-aircraft-position profiles corresponding to the dynamic simulation of reduced-visibility events.

FIG. 20 illustrates an exemplary visibility-versus-pilot-condition profile corresponding to the dynamic simulation of a reduced-visibility event.

FIGS. 21A-21C illustrate exemplary visibility profiles corresponding to dynamic simulation of reduced-visibility events.

FIG. 22 illustrates an exemplary reduced-visibility-training system.

FIG. 23 illustrates an exemplary flow chart for simulating a reduced visibility event according to a visibility profile.

### DETAILED DESCRIPTION OF THE INVENTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature to convey the structural nature of that feature. Such reference to function of a structural feature is not reference to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component is “substantially” opaque if the optical transmittance of the component is such as to equivalently satisfy the technological purpose the component being exactly opaque.

Except as otherwise stated herein, or as is otherwise clear from context, the term “or” is used herein in its inclusive sense. For example, “A or B” means “A or B, or both A and B.”

As used herein, “electrooptic material” refers to a material with optical characteristics that can be electrically controlled.

As used herein, “optical transmittance” refers to the amount of light transmitted through a material expressed as a percentage of the amount of light incident on a material.

As used herein, “optical apparel” refers to an optical device configured to be worn by a person, such as eyeglasses, goggles, and flight-helmet visors.

In the context of entry into reduced-visibility conditions, “unexpected” refers to the pilot's expectations at the exact moment of entry into such conditions. For example, while the pilot may expect that at some moment he may enter into such conditions he does not know at any given moment whether he will enter into such conditions at that moment.

Electrooptic materials are well known in the art. In particular, electrooptic materials having an optical transmittance that can be controlled by applying a voltage or current to the material are well known in the art. These materials include “switchable glass” and “smart windows.” For certain electrooptic materials, the transmittance can be changed between a minimum and maximum transmittance with application of a voltage or current. Other electrooptic materials have a transmittance that varies somewhat continuously with the applied voltage or current. Electrooptic materials include Polymer Dispersed Liquid Crystals (PDLCs), Suspended Particle Devices (“SPDs”), electrochromic devices, and micro-blinds.

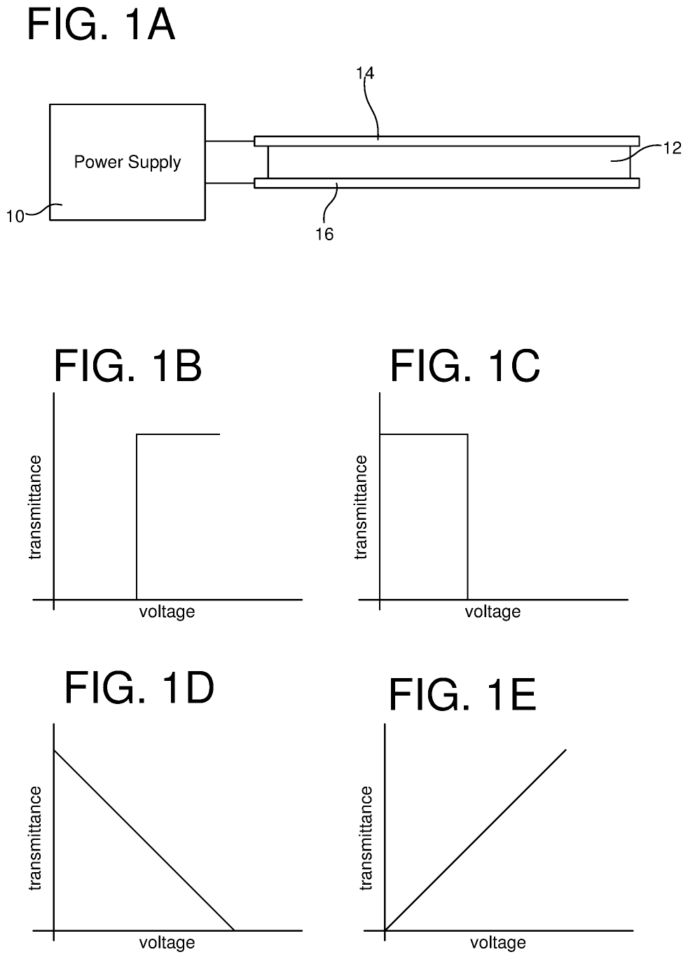

FIG. 1A depicts a basic circuit for a voltage-controlled electrooptic material. An electrooptic material 12 is disposed between two electrodes 14, 16. The electrodes 14, 16 are connected to the output terminals of a power supply 10. The power supply 10 provides an electrical signal (e.g., AC or DC voltage) across the terminals such that the electrodes 14, 16 provide the signal to the electrooptic material 12. The power supply 10 may be a fixed-output power supply; i.e., a power supply having an output voltage that is not variable other than to be on or off (e.g., a power supply that outputs 12 VAC when on and 0 VAC when off). The power supply 10 may be a programmable-output power supply (also known as a programmable power supply); i.e., a power supply having an output voltage that depends on an input, such as current, frequency, or data. Both fixed-output power supplies and programmable-output power supplies are well-known in the art.

FIGS. 1B-1E depict idealized transmittance-vs-voltage response curves for various electrooptic materials. In general, the transmittance of an electrooptic material can depend on the applied voltage in a number of ways, depending on the material. The idealized curve of FIG. 1B represents a material that is substantially opaque when the applied voltage is below a certain level and has a constant non-zero transmittance when the voltage is at or above the level. The idealized curve of FIG. 1C represents a material that has a constant non-zero transmittance when the applied voltage is below a certain level and is substantially opaque when the voltage is at or above the level. The idealized curve of FIG. 1D represents a material that has a transmittance that varies inversely with the applied voltage and the idealized curve of FIG. 1E represents a material that has a transmittance that varies with the applied voltage. Some electrooptic materials will have a transmittance that changes with application of a voltage and then remains constant at the new transmittance level when voltage ceases to be applied and until a voltage is again applied.

The curves depicted in FIGS. 1B-1E are idealized. The actual transmittance curves may vary from the ideal. For example, the idealized curves of FIGS. 1B and 1C show a sharp switch from the substantially transparent state to the substantially opaque state. The actual response will typically have a more gradual transition from state to state. Similarly, the idealized curves of FIGS. 1D and 1E are depicted as linear. The actual curves need not be linear. The idealized curves are presented for a basic explanation of background principles well known in the art of electrooptic materials and are not intended to limit the invention.

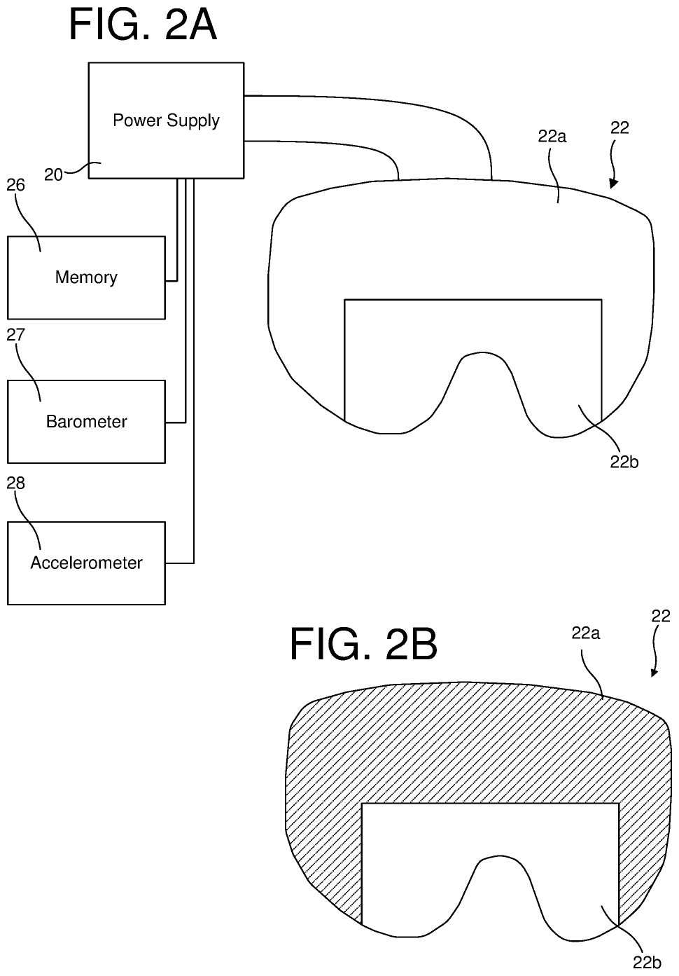

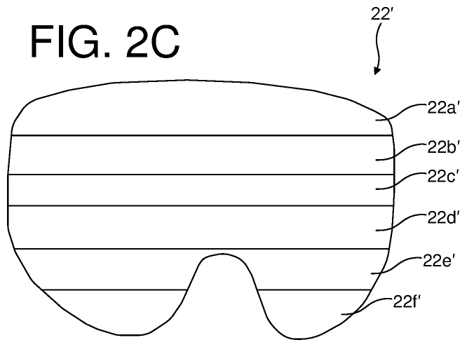

An exemplary embodiment of a vision-limiting device according to the invention is depicted in FIG. 2A. A lens 22 comprises a portion of electrooptic material 22a and a portion of transparent material 22b. The electrooptic material 22a may be disposed on or in a transparent lens substrate or may act as the lens substrate. The lens 22 is configured to be donned by the pilot. For example, the lens may be used to form or fit on the lens portion of glasses or googles worn by the pilot, the visor portion of flight helmet worn by the pilot, or the lens portion of night vision goggles worn by the pilot. The transparent material 22b is configured such as to allow the pilot to view the aircraft's instruments regardless of the optical transmittance state of the electrooptic material 22a. The electrooptic material 22a is configured such as to reduce the pilot's vision other than through the transparent material 22b by reducing the optical transmittance of the electrooptic material 22a. The lens 22 is depicted in FIG. 2B with the electrooptic material 22a in the substantially opaque state.

A power supply 20 is connected to the electrooptic material 22a in the manner described with reference to FIG. 1A. The optical transmittance of the electrooptic material 22a can be manipulated according to the transmittance-vs-voltage response curve for the material 22a. The output of the power supply may be controlled manually, or it may be controlled automatically using output levels that are stored in memory 26 (e.g., volatile memory, such as random-access memory, or nonvolatile memory, such as flash memory or magnetic disk). Thus, the field of the pilot's view may be restricted by changing the output of the power supply to a voltage that corresponds to a lower transmittance state of the material 22a. This change may be performed manually by someone other than the pilot, for example, by the training pilot. Or the change may be automatic based on a power-supply output profile stored in memory 26. In this way, the vision-limiting device may be used to simulate the unexpected entry into reduced-visibility conditions.

The power supply 20 may be connected to safety sensors that provide information to control the output of the power supply and thereby the optical transmittance state of the electrooptic material 22a. For example, the power supply 20 may be connected to a barometer 27 and the transmittance state of the material 22a is controlled by the pressure reading from the barometer 27. For example, the transmittance state may be set to maximum transmittance for air pressures above a certain reading (corresponding to low altitudes). Or the transmittance state may be set to maximum transmittance for a change in air pressure greater than some value per unit time (such as might occur in a rapid decent). Likewise, the power supply 20 may be connected to an accelerometer 28 to control the transmittance state of the material 22a based on current acceleration or changes in acceleration (such as might occur in a spinning or rotating aircraft). The power supply 20 may be connected to other devices, such as an airspeed indicator, altimeter, and any of the various sensors found in an aircraft. In this way, the transmittance state may be tied to different measures of flight conditions.

The sensors connected to the power supply 20 are used to implement training safety measures. For example, a barometer 27 may be used as a safety device that disables the vision-limiting capability of the vision-limiting device under certain conditions, such as a too-rapid descent or a too-close proximity to the ground. An altimeter, GPS monitor, or other altitude sensor would function similarly. Similarly, an accelerometer 28 may be used to disable the vision-limiting capability of the vision-limiting device when acceleration exceeds some predetermined level. Other measures that may be used to disable the vision-limiting device include GPS position (which may include altitude information), oil pressure, aircraft electrical power, fuel level, among other aircraft performance measures. Pilot performance measures, such as heart rate and blood pressure may be similarly used. For example, the vision-limiting device may be disabled if the pilot's heart rate or blood pressure exceeds some predetermined threshold. In this way, the transmittance state may be set so that the vision-limiting device does not interfere with the pilot in circumstances under which such vision interference may pose unacceptable risks to safety. An Automatic Dependent Surveillance-Broadcast (ADS-B) system may also be used to implement training safety measures. For example, the vision-limiting device may be disabled if the ADS-B system indicates approaching or nearby aircraft or imminent dangerous weather conditions.

The power supply 20 may also be controlled to automatically trigger the simulation of unexpected entry into reduced visibility conditions based on safety-sensor input. For example, a timer connected to the power supply 20 may change the optical transmittance state of the electrooptic material 22a based on time from some event, such as reaching a certain altitude or airspeed. In this way, the transmittance state may be set to safely simulate unexpected entry into reduced-visibility conditions without manual manipulation by a training pilot.

The memory 26 may store transmittance and safety-sensor information generated during the training session. This data may be reviewed and analyzed after the training session to help the pilot understand how she performed during the sessions and how to improve the performance. The session data can also be used to improve the quality of the training sessions and to determine best practices and common pilot mistakes during unexpected entry into reduced-visibility conditions.

While the memory 26, barometer 27, and accelerometer 28 are depicted in this exemplary embodiment as separate from the power supply 20, they, and other sensors and components, may equivalently be integrated with the power supply 20.

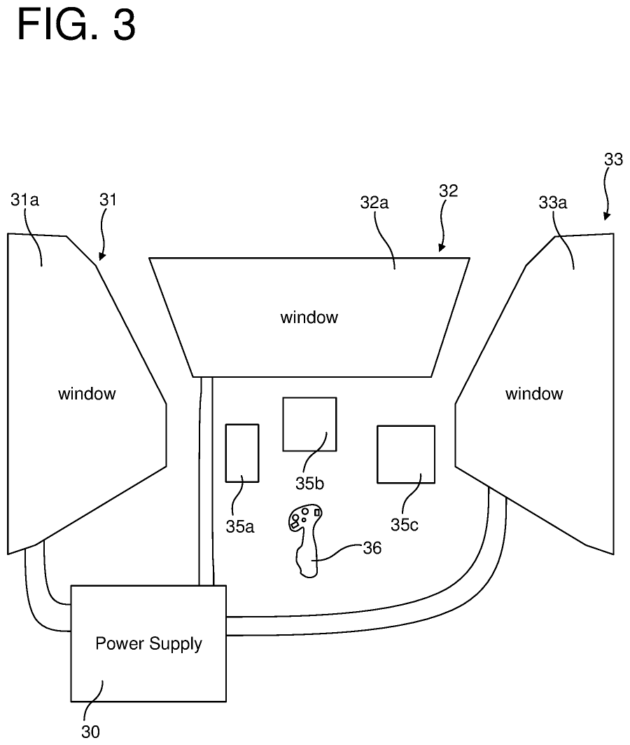

Another exemplary embodiment of a vision-limiting device according to the invention is depicted in FIG. 3. The vision-limiting device is disposed within the cockpit of an aircraft. The cockpit is depicted with three windows 31, 32, 33. Each window comprises or consists of an electrooptic material 31a, 32a, 33a. Each electrooptic material 31a, 32a, 33a is connected to a power supply 30 in the manner described with reference to FIG. 1A above. Operation of the power supply 30 to selectively limit the pilot's vision to simulate unexpected entry into reduced-visibility conditions is generally the same as described with reference to FIGS. 2A and 2B above.

The embodiment depicted in FIG. 3 includes multiple instances of electrooptic material 31a, 32a, 33a the transmittance state of which may be separately controlled to limit vision in certain directions and not others, or to limit vision differently in certain directions and not others. Such a cockpit-disposed embodiment does not require multiple instances of electrooptic material. For example, one instance of the material may be disposed on all the windows or between the pilot and the windows. Similarly, the lens embodiment of FIG. 2A may include more than one instance of electrooptic material that may be separately controlled as depicted in FIG. 3. For example, glasses or googles that have two separate lenses may have two separate instances of electrooptic material that may be separately or jointly controlled. In another variant, illustrated in FIG. 2C, a lens 22′ comprises several portions of electrooptic material 22a′, 22b′, 22c′, 22d′, 22e′, 22f′. The transmittance state of each portion may be separately controlled so that, for example, the top portions of the lens may have a lower transmittance than the lower portions. This variant may be used in conjunction with a sensor that determines the inclination of the lens (and thus the direction of the pilot's gaze) so as to ensure the pilot can not simply raise his head and look through the higher transmittance lower portions to defeat the simulation. For example, an accelerometer or inclinometer may be used to determine the direction of the pilot's gaze and to accordingly vary the transmittance state of each portion 22a′, 22b′, 22c′, 22d′, 22e′, 22f′ to ensure the horizon is obscured and thereby maintain the simulation of the reduced-visibility condition.

Various flight instruments 35a, 35b, 35c and a control stick 36 are also depicted in FIG. 3. As these are within the cockpit, the pilot's view of these will not be limited by the transmittance state of the electrooptic materials 31a, 32a, 33a. The power supply 30 may be connected to or include memory or safety sensors as described with reference to FIG. 2A above. The connected sensors may include the flight instruments 35a, 35b, 35c and the control stick 36. For example, a control-stick sensor may indicate whether the pilot has released the control-stick and, if so, disable the vision-limiting device.

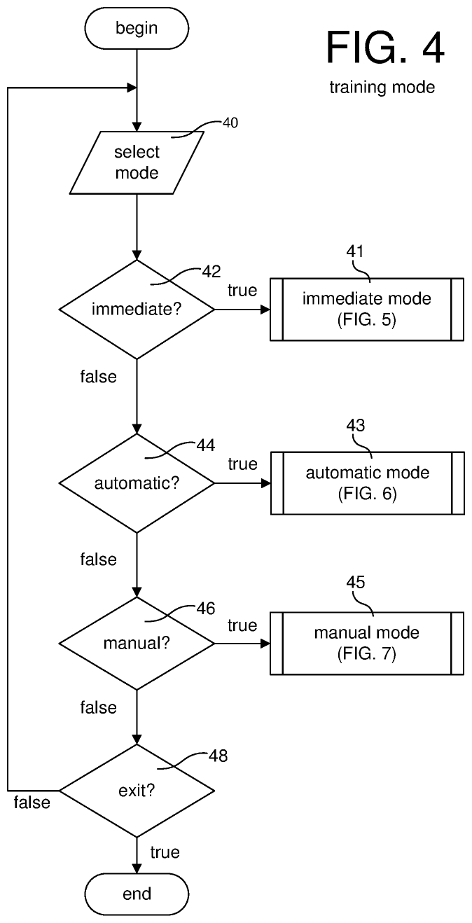

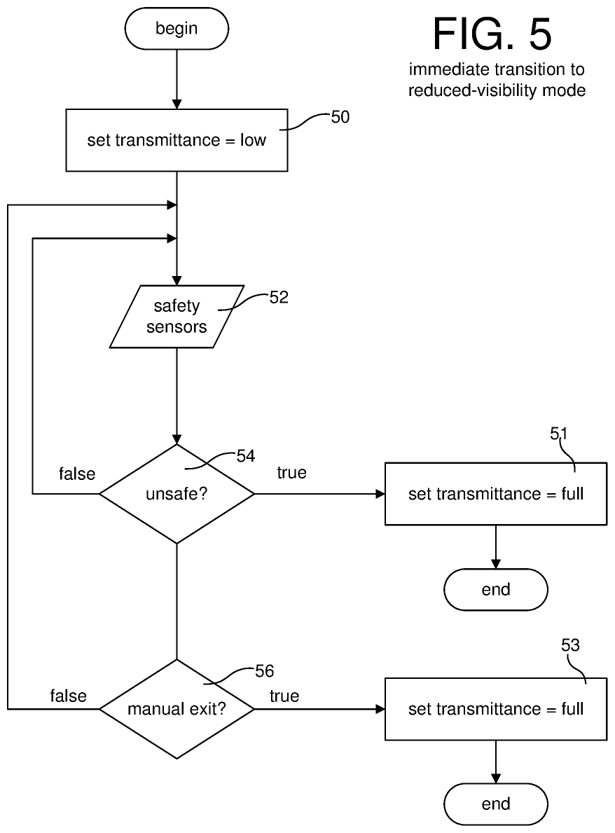

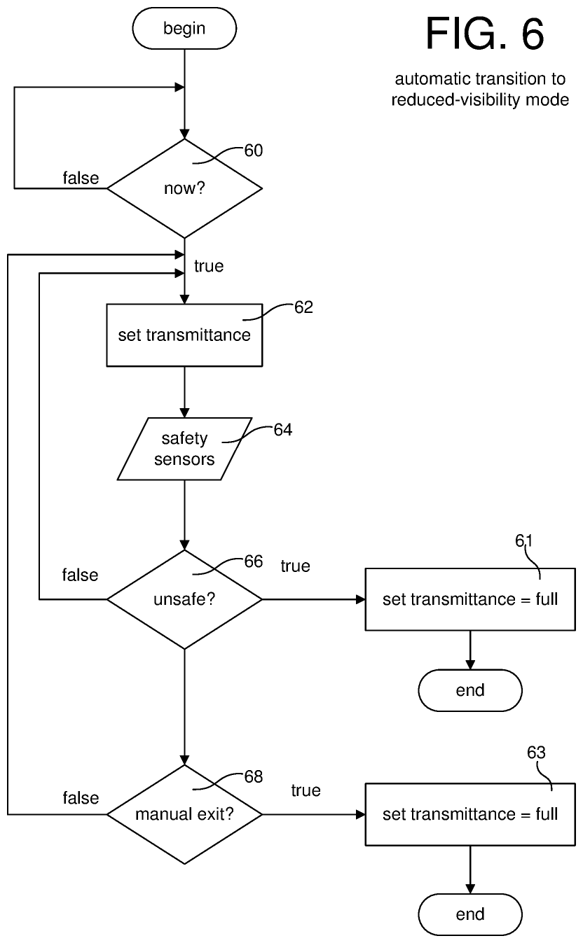

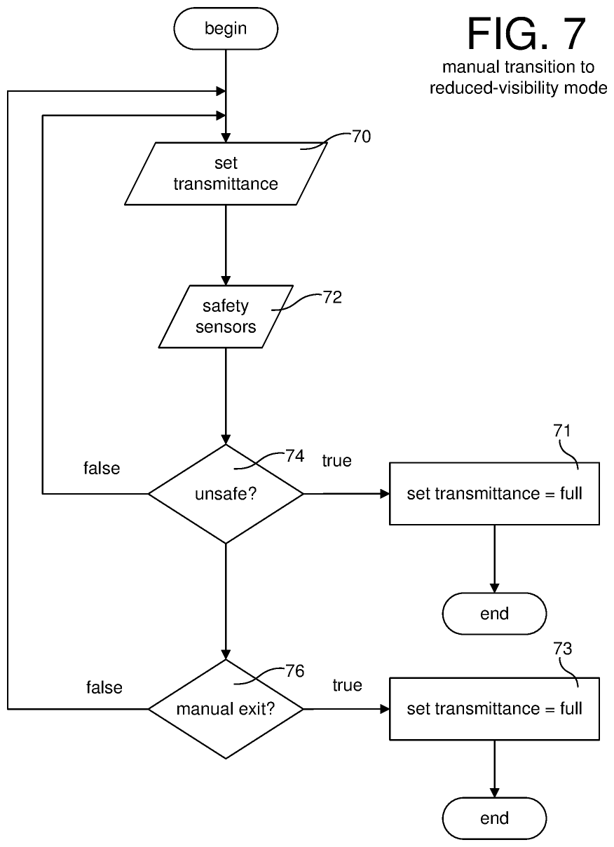

Exemplary training flows are shown in FIGS. 4-7. As shown in FIG. 4, the pilot or the trainer may select the training mode 40. Three training modes 42, 44, 46 are depicted in this flow: immediate 41, automatic 43, and manual 45. If the immediate mode 41 is selected, as determined at the “immediate?” decision step 42, the flow depicted in FIG. 5 is invoked. If the automatic mode 44 is selected, as determined at the “automatic?” decision step 44, the flow depicted in FIG. 6 is invoked. If the manual mode 45 is selected, as determined at the “manual?” decision step 46, the flow depicted in FIG. 7 is invoked. The selection mechanism may be implemented in hardware (e.g., a four-position switch or a series of switches) or software (e.g., a “switch” statement or a series of “if . . . then” statements based on user input). Alternatively, a given system may provide other training-mode options, such as only the immediate and manual modes, only the manual mode, or a custom mode. The training modes differ in how the transmittance of the electrooptic material is varied to occlude the pilot's vision to simulate a sudden-onset reduced-visibility event.

An exemplary immediate training mode 41 is depicted in FIG. 5. In this mode, the transmittance of the electrooptic material is directly set to a low value 50, such as substantially opaque. This means the power supply is set to output the voltage corresponding to the low-transmittance state using a slope (change in output voltage per unit time) that is dictated by the system (including the power supply, electrooptic material, and the connections) rather than by a training goal. Any safety sensors incorporated into the training process will be periodically read 52 and their values will be compared with predetermined values 54. If the comparison indicates that the continued reduced visibility is unacceptable, the electrooptic material will be set to a maximum transmittance state 51 and the training event will end. For example, if the altitude of the aircraft is below some minimum height or above some maximum height, the training event will be deemed unsafe and will automatically end. This can be expressed in pseudocode as “if sensor_altitude<minimum_altitude or sensor_altitude>maximum_altitude, then transmittance=full, end training.” The training mode may also be terminated manually 56, 53, for example, by engaging or disengaging a hardware or software switch. This interrupts the flow and terminates the training. While the immediate mode is described here as including a single transmittance state, it may optionally include multiple transmittance states as explained below. In this immediate mode, a trainer triggers the reduced-visibility event so that the pilot-in-training does not know her vision is going to be limited at the moment it is limited. In this way, the immediate training mode simulates the sudden onset of a reduced-visibility event.

An exemplary automatic training mode 43 is depicted in FIG. 6. In this mode, the moment that the pilot's visibility is reduced is determined in a pseudorandom fashion 60. Whether to start the reduced-visibility event may be based on, for example, time since take off or time since reaching a particular altitude. In this example, the amount of time would be unknown to the pilot and may, for example, be randomly selected within certain parameters or set before the training flight. As shown in FIG. 6, this mode may also include changing the transmittance over time in a particular controlled fashion. Once the reduced-visibility event has begun, the transmittance of the electrooptic material may be periodically set to different values 62. The transmittance setting may also persist over the duration of the training event. Data from safety sensors 64 maybe periodically checked 66 to determine if the aircraft is being operated in an unsafe condition, and, if so, the transmittance will be set to full 61 and the training event terminated as explained above. Also as explained above, the training event may be terminated manually 68, 63. While the periods of transmittance changes, safety checks, and manual-exit checks are shown as the same in FIG. 6, these need not be the same. For instance, a manual exit may be accomplished at any point via a manual switch or through software interrupt processing. And the transmittance may be varied more or less often than the safety sensors are checked. The key to the automatic mode is that the pilot does not know exactly when her vision will be reduced once the training event begins. In this way, the automatic training mode simulates the sudden onset of a reduced-visibility event.

An exemplary manual training mode 45 is depicted in FIG. 7. This mode differs from the previously described immediate mode in that the trainer manually sets the transmittance of the material 70. This may be done, for example, by manually manipulating a hardware control (such as a knob controlling a potentiometer) or a software control (such as a dial on a graphic user interface that sets the power supply output). Data from safety sensors 72 maybe periodically checked 74 to determine if the aircraft is being operated in an unsafe condition, and, if so, the transmittance will be set to full 71 and the training event terminated as explained above. Also as explained above, the training event may be terminated manually 76, 73. The key to the manual mode is that the pilot does not know exactly when her vision will be reduced. In this way, the manual training mode simulates the sudden onset of a reduced-visibility event.

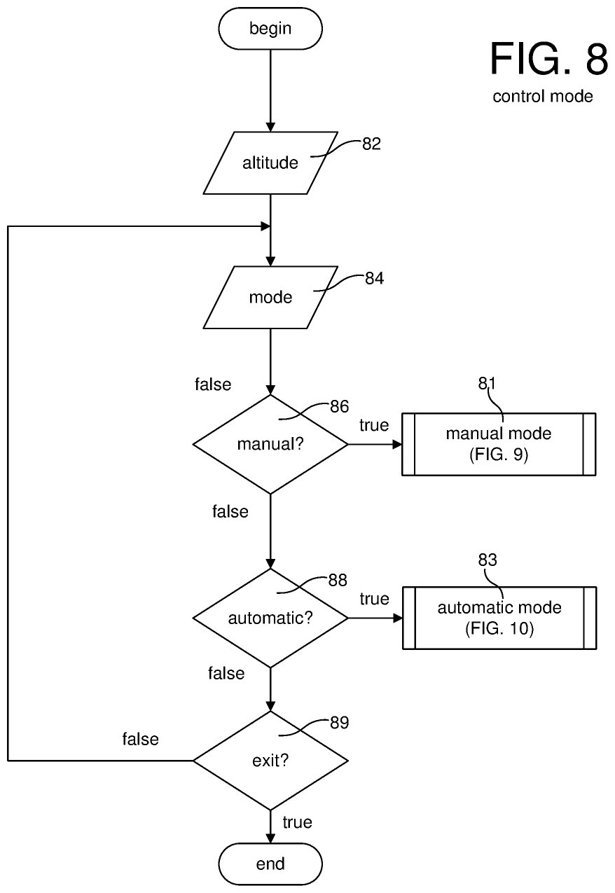

Exemplary control flows are depicted in FIGS. 8-10. As shown in FIG. 8, the altitude value is measured 82 and the control mode is selected or entered 84. The control mode may be selected through hardware (e.g., switch) or software (e.g., input data, menu selection). Two exemplary modes are depicted in FIG. 8: a manual mode 81 and an automatic mode 83. The modes differ in how the safety criteria are set.

An exemplary manual control mode 81 is depicted in FIG. 9. The user may independently select and set the safety criteria used in the training mode. Here, the maximum aircraft roll rate may be set, 90a, 91a, the maximum bank angle may be set 90b, 91b, the maximum aircraft pitch angle may be set 92, 93, and the minimum aircraft altitude may be set 94, 95. Once the safety criteria are selected and set, the user may choose to enter a training event or to exit 96. If the user selects to begin a training event, he may choose among different types of training events (e.g., IIMC 96a and DVE 96b). The type of training event determines the transmittance-versus-time profile used in the training mode 97, 99. The transmittance-versus-time profile may be selected or entered by the user, or may be set by default according to the type of event. For example, a DVE training event may include transmittance-versus-time profile options associated with light, medium, and heavy environments (progressively less transmittance, respectively). Once the transmittance profile is set, the system proceeds to a training-mode flow as previously described.

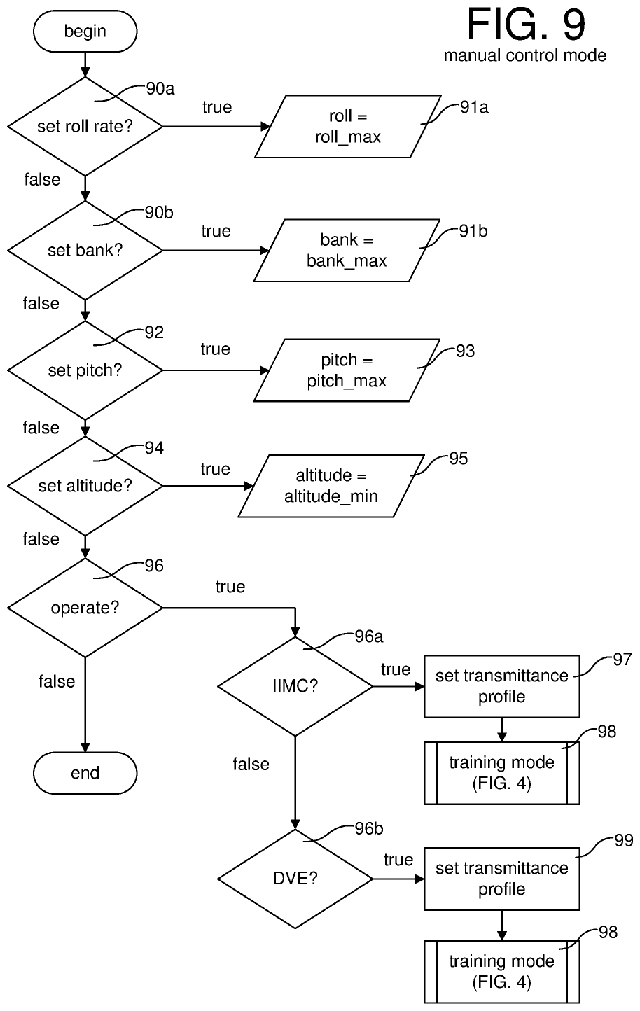

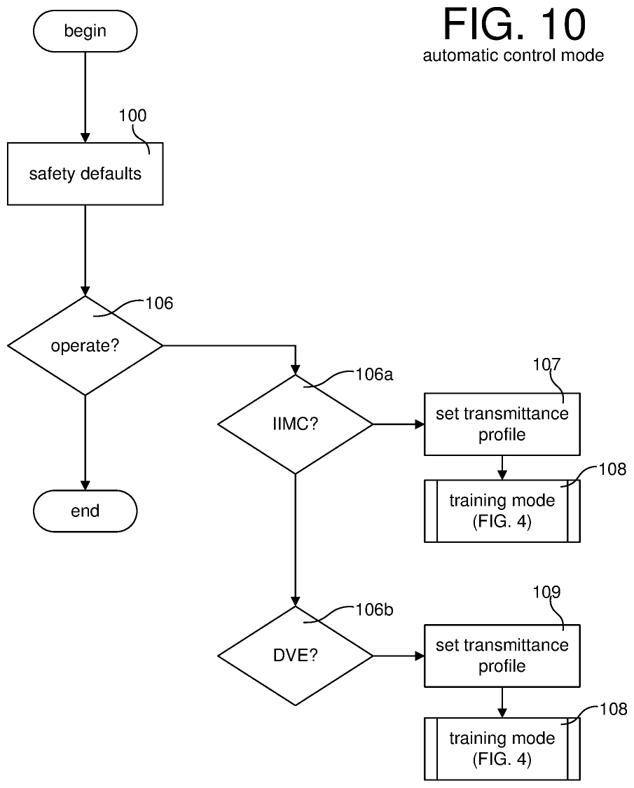

An exemplary automatic control mode 83 is depicted in FIG. 10. This differs from the exemplary manual control mode of FIG. 9 in that safety criteria are selected and set 100 by default. This may be a factory default or may be a user-defined default. A user may define default safety criteria by, for example, uploading a text or binary file with the measurement type and value or by saving as the default a configuration established in the manual control mode.

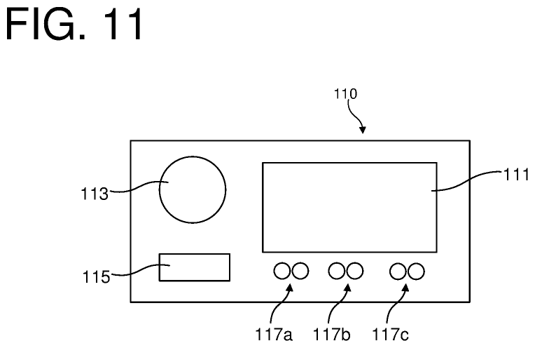

An exemplary power-supply/control unit 110 is depicted in FIG. 11. It includes a display 111, a control knob 113, a programmable button 115, and power-output ports 117a, 117b, 117c. The unit 110 may be powered by either AC or DC power. The unit 110 includes a standard programmable power supply to convert the supply voltage/current to the programmed output voltage/current for the electrooptic material.

The unit 110 also includes sensors to measure pitch, roll rate, and bank (e.g., gyroscopes and accelerometers), a GPS unit, and associated support circuitry for the sensors and unit (e.g., discrete circuits, application-specific ICs, programmable logic, processor). The GPS unit provides position, velocity, and altitude information. The gyroscope and accelerometers provide pitch, roll rate, and bank angle information. The gyroscope may be any of the various gyroscope forms, such as a mechanical gyroscope, a MEMS gyroscope, a fiber optic gyroscope, a digital gyroscope, and a ring laser gyroscope. Likewise, the accelerometer may be any of the various forms of accelerometers, such as a laser accelerometer, a magnetic-induction accelerometer, an optical accelerometer, and a strain-gauge accelerometer.

The unit 110 may also include a communications interface by which the unit 110 can communicate with external computers or sensors. For example, the unit 110 may communicate with a computer or sensor via a general purpose interface bus (GPIS), Ethernet, universal serial bus (USB), or Wi-Fi. Such a configuration may be used, for example, to pass control of the power supply to an external computer or to use safety sensors not integral to the unit 110.

The power-supply/control unit 110 is turned on by pressing and holding the control knob 113 for two to three seconds. When on, the display 111 will show a welcome message for three to six seconds. This welcome screen is followed by a power-level screen visible for two to three seconds. Then a current altitude will be shown for three to five seconds.

The display 111 then shows a prompt for the user to select manual control or automatic control, such as “Operation Mode?” with “Man or Auto.” “Man” or “Auto” may be selected by rotating the control knob 113 to appropriately position a cursor and by pressing the control knob 113 to select highlighted option. If “Man” is selected, the next screen shows “Custom Safety Settings?” with the words “YES or NO.” “YES” or “NO” may be selected by rotating the control knob 113 to appropriately position the cursor and by pressing the knob 113 to select highlighted option. If “NO” is selected, the safety settings are set to the default of roll rate=30 degrees/second, bank angle=45 degrees, pitch angle=15 degrees, and altitude=300 feet above the altitude at the time the power-supply/control unit 110 is powered on. If “YES” is selected, then the next screen will display “ROLL RATE?” The maximum roll rate may be entered by rotating the knob 113 until the desired maximum roll rate is displayed then pressing the knob 113 to accept the value. The next screen displays “BANK?” The maximum bank angle may be entered by rotating the knob 113 until the desired maximum bank angle is displayed then pressing the knob 113 to accept the value. The next screen displays “PITCH?” The maximum pitch angle may be entered by rotating the knob 113 until the desired maximum pitch angle is displayed then pressing the knob 113 to accept the value. Optionally, the power-supply/control unit 110 may assign the negative of the entered maximum pitch angle as the minimum pitch angle (e.g., entry of 30 degrees sets the maximum pitch angle to 30 degrees and the minimum pitch angle to −30 degree) or the unit 110 may separately prompt for entry of a minimum pitch angle (e.g., “MAX PITCH?” and “MIN PITCH” are separate prompts). The next screen displays “Min ALT?” The minimum altitude may be entered by rotating the knob 113 until the desired minimum altitude is displayed then pressing the knob 113 to accept the value. Thus, the safety criteria are set for use in a training mode as described above. After all settings are entered, the display 111 will show a confirmation screen showing the safety settings that were entered, or the default settings if “NO” was selected. The knob 113 may be pressed momentarily to accept or held for two to three seconds to reenter the settings menu. If the settings are confirmed, and the unit 110 is place in manual training mode, a number will be shown on the display 111 that represents the transmittance setting for the electrooptic material (e.g., in the pilot's visor). The knob 113 is used to manually control the transmittance level. Rotating the knob 113 counterclockwise will dial down the transmittance from 100% toward a minimum of 0% (or bounded by the maximum and minimum transmittance settings for a particular electrooptic material).

If “Auto” is selected when the display 111 shows a prompt for the user to select manual control or automatic control, the safety settings default roll rate=30 degrees/second, bank angle=45 degrees, pitch angle=15 degrees, and altitude=300 feet above the altitude at the time the power-supply/control unit 110 is powered on.

Once the safety criteria are set, the display 111 will prompt for the desired type of training event: IIMC or DVE. It will display “Training?” with “IIMC” and “DVE” at the bottom. “IIMC” or “DVE” may be selected by rotating the control knob 113 to appropriately position the cursor and by pressing the control knob 113 to select highlighted option. If “IIMC” is selected the screen will display “Press button to initiate.” When the button 115 is pressed, the power-supply/control unit 110 will randomly select when the transmittance will start to change as well as a random, predetermined, or user-selected rate at which it will change. The display 111 will show “press button to end.” Once the training is complete, pressing the button 115 will end the session and reset the electrooptic material to maximum transmittance. The display 111 will once again show the “Press button to initiate” screen.

If “DVE” is selected at the “Training?” prompt, the power-supply/control unit 110 will control the altitude at which the transmittance of the electrooptic material begins to change and the rate at which it changes based on groundspeed and altitude along with the dust environment to be simulated, i.e. light, medium or heavy. The display 111 will show “Choose Dust Environment?” and “Light Medium Heavy.” The dust environment may be selected by rotating the control knob 113 to highlight the appropriate option, and then pressing the knob 113. After selecting the dust environment to be simulated, the display 111 will show “Press button to initiate.” When the button 115 is pressed, the power-supply/control unit 110 will output a voltage to the electrooptic material that is a function of altitude, ground speed, and the selected dust environment. During operation, the display 111 will show “press button to end.” Once the training is complete, pressing the button 115 will end the session and reset the electrooptic material to maximum transmittance. The display 111 will once again show the “Press button to initiate” screen.

The power-supply/control unit 110 may be placed in a different mode at any time by pressing the control knob 113 for two to three seconds. The display will read “SET or OFF.” The desired option may be selected by rotating the control knob 113 until the appropriate option is highlighted, and then pressing the knob 113. The unit 110 will either go back to the operation mode screen and the user can make the desired selections (“SET”) or power down (“OFF”).

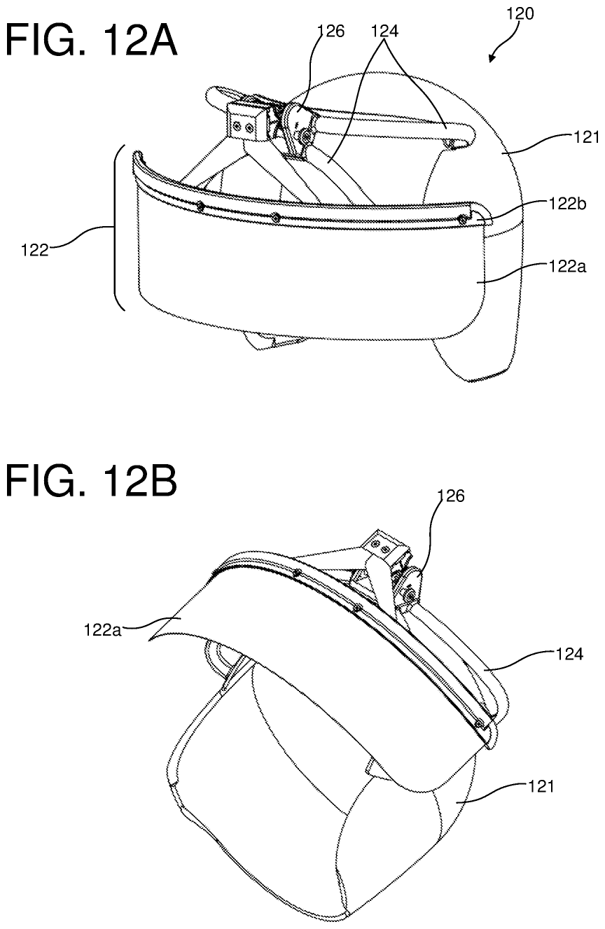

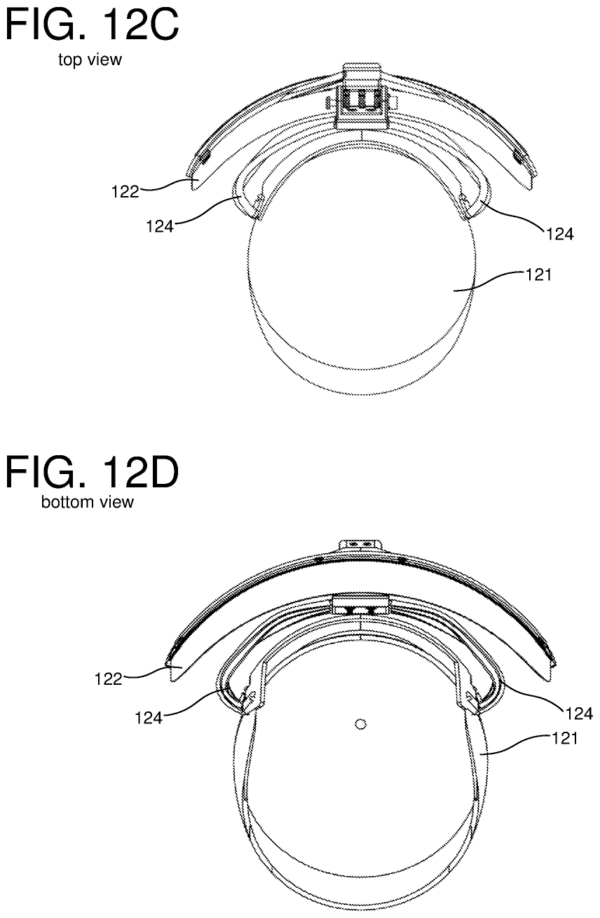

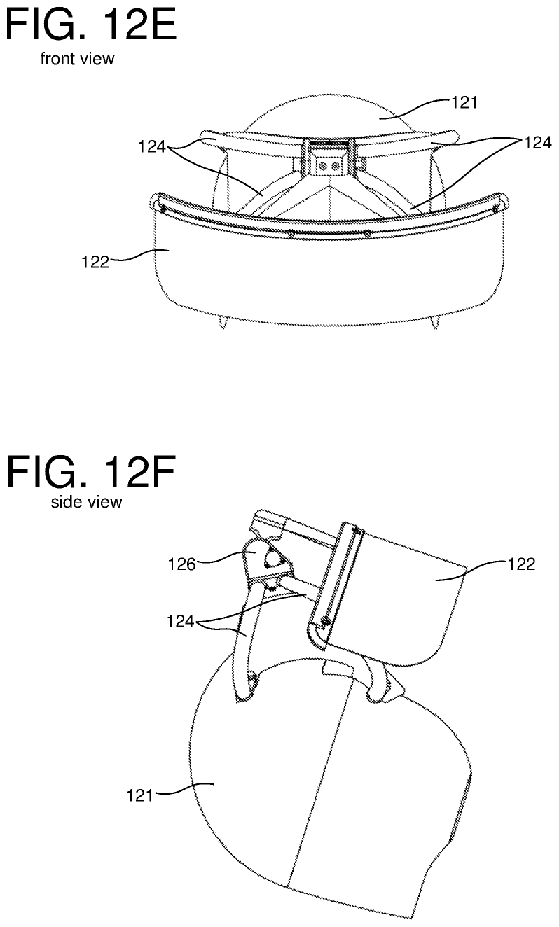

Various views of an exemplary embodiment of a vision-limiting device 120 according to the invention is depicted in FIGS. 12A-12F: FIGS. 12A and 12B provide three-dimensional views of the device, FIG. 12C provides a top view, FIG. 12D provides a bottom view, FIG. 12E provides a front view, and FIG. 12F provides a side view. The device includes a visor 122 that is mountable to a flight helmet 121 using a bracket 124 and a hinge mount 126. The visor 122 includes an electrooptic material 122a and a material mount 122b. The bracket 124, hinge mount 126, and material mount 122b include electrically transmissive paths to provide the voltage/current to the electrooptic material 122a. The transmissive paths may, e.g., include wires in the bracket 124, an electrical connector in the hinge mount 126, and wires and electrodes in the material mount 122b. Through the transmissive paths, the visor 122 is connected to a power supply configured to control the optical transmittance of the electrooptic material 122a (e.g., the power supply 20 described with reference to FIG. 2A and the power-supply/control unit 110 described with reference to FIG. 11). Electrically transmissive paths may also be provided to connect a power-supply/control unit to an automated-positioning actuator (an exemplary version of which is described below).

The bracket 124 and hinge mount 126 are structured to hold the visor 122 out from the helmet 121 such that the visor can accommodate other optical devices integrated into the helmet or worn by the pilot. For example, the helmet may include a mounted heads-up-display (HUD) that the pilot references during normal operation of the aircraft. In another example, the pilot may wear night-vision goggles during normal night-time operation of the aircraft. The bracket 124 and hinge mount 126 are structured to allow such optical devices so that the only change to the pilot's normal operation of the aircraft due to the vision-limiting device 120 is due to: (1) the rotational position of the visor and (2) the optically transmissive state of the visor. This enables, for example, a return to the pilot's normal operating state when a flight-safety sensor indicates that a reduced-visibility training session should be terminated due to unsafe conditions.

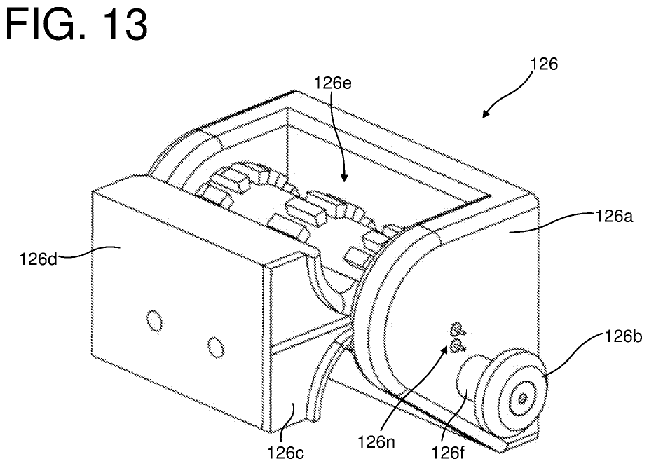

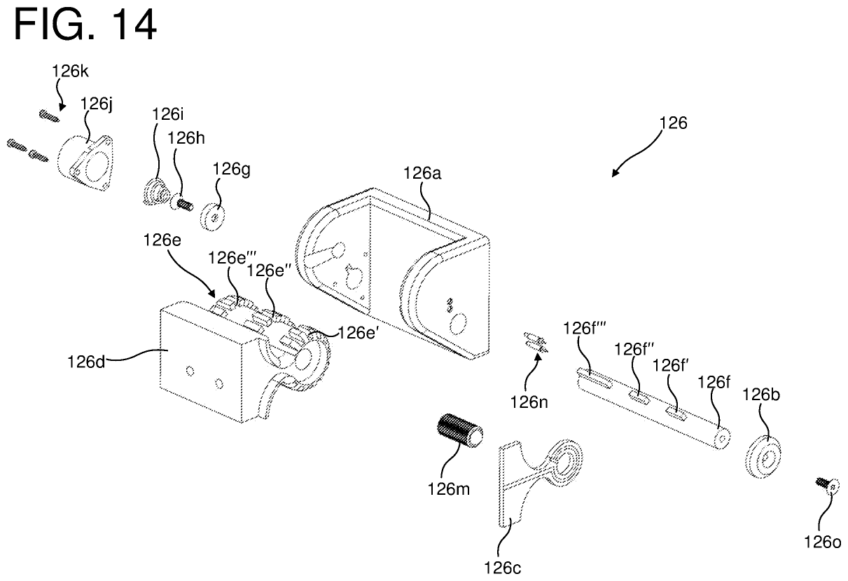

FIG. 13 is a three-dimensional view of an exemplary hinge mount 126 shown detached from the visor 122 and bracket 124. FIG. 14 is an exploded view of the hinge mount 126 shown in FIG. 13. The hinge mount 126 includes a bracket-mounting portion 126a, a visor-mounting portion 126d, a keyed pivot 126e, a keyed shaft 126f, and a shaft cap 126b. The keyed pivot 126e, here integrated with the visor-mounting portion 126d, is mounted in the bracket-mounting portion 126a using ball plungers 126m pressed into the pivot 126e and configured to fit into depressions in the bracket-mounting portion 126a and thereby acting as a pivot axis. The keyed shaft 126f is mounted in the bracket-mounting portion 126a such that the raised features 126f′, 126f″, and 126f′″ on the shaft 126f may engage grooved features 126e′, 126e″, and 126e′″ on the pivot 126e. The keyed shaft 126f may be positioned within the bracket-mounting portion 126a such that the raised features 126f′, 126f″, and 126f′″ engage the grooved features 126e′, 126e″, and 126e′″ of the pivot 126e, thus locking the visor 122 in place relative to the flight helmet 121. The keyed shaft may also be positioned within the bracket-mounting portion 126a such that the raised features 126f′, 126f″, and 126f′″ disengage the grooved features 126e′, 126e″, and 126e′″ of the pivot 126e, thus allowing the visor 122 to rotate with respect to the flight helmet 121. A shaft spring 126i is positioned and constrained with respect to the bracket-mounting portion 126a using spring housing 126j attached to the bracket-mounting portion 126a with screws 126k. The shaft spring 126i pushes on a screw 126h attached to one end of the keyed shaft 126f and thereby positions the keyed shaft 126f such that the raised features 126f′, 126f″, and 126f′″ engage the grooved features 126e′, 126e″, and 126e′″ of the pivot 126e. A shaft cap 126b is attached to the other end of the keyed shaft 126f with a screw 126o. By applying a force to the shaft cap 126b the shaft spring 126i may be compressed and the shaft 126f moved to disengage the raised features 126f′, 126f″, and 126f′″ from the grooved features 126e′, 126e″, and 126e′″ of the pivot 126e, thereby freeing the visor 122 to pivot with respect to the flight helmet 121. For example, a pilot wearing the flight helmet 121 may release the visor 122 by pressing on shaft cap 126b and then pivot the visor 122 into or out of position to restrict his vision during a training session. The pivot 126e may be spring loaded with, for example, a torsion spring to provide a spring force to cause the pivot 126e—and the attached visor—to pivot up out of the position that restricts the pilot's vision.

An electrically transmissive path through the hinge mount is provided through two spring-loaded contacts 126n mounted in the bracket-mounting portion 126a and a board 126c holding two copper traces and mounted to the keyed pivot 126e/visor-mounting portion 126d. The contacts 126n are electrically connected to the power supply. The copper traces on the board 126c are electrically connected to the electrooptic material 122a. Alternative structures may equivalently connect the electrooptic material 122a to a power supply. For example, a wiring harness including wires directly connected to the electrooptic material 122a may be attached to the bracket 124.

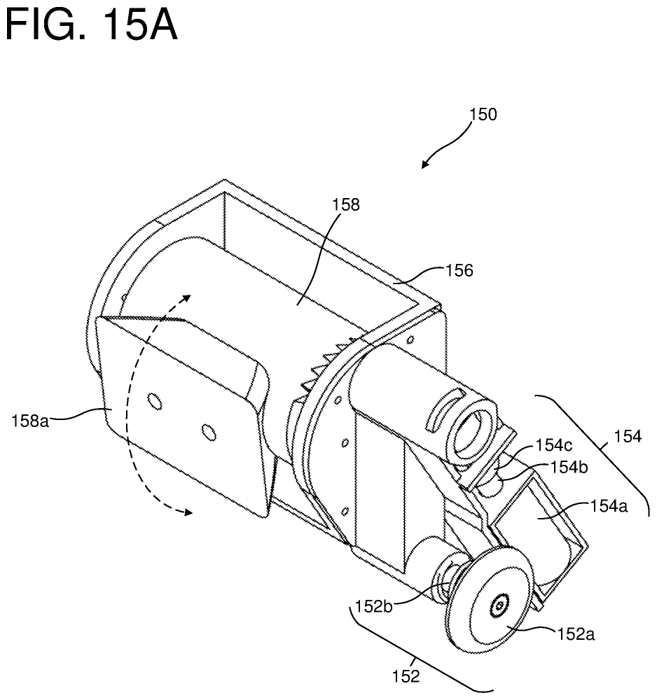

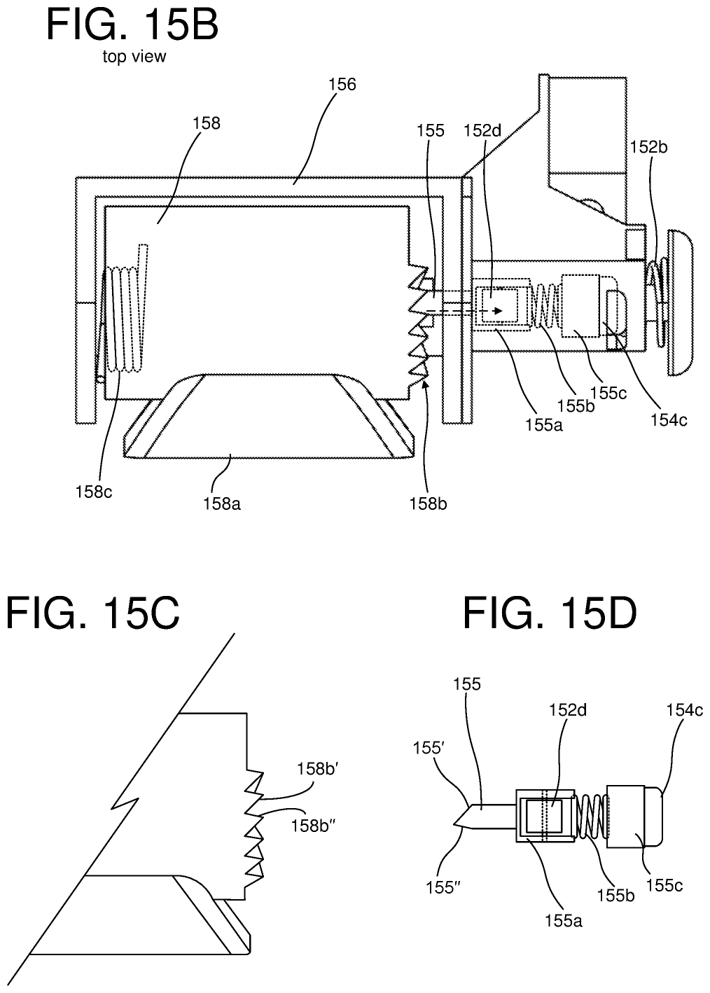

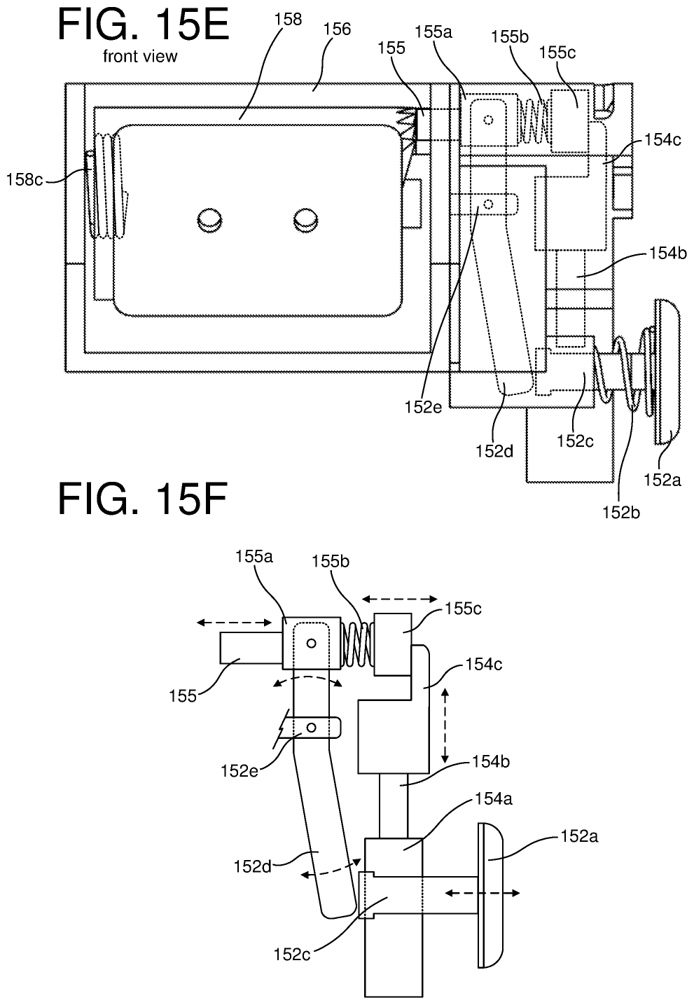

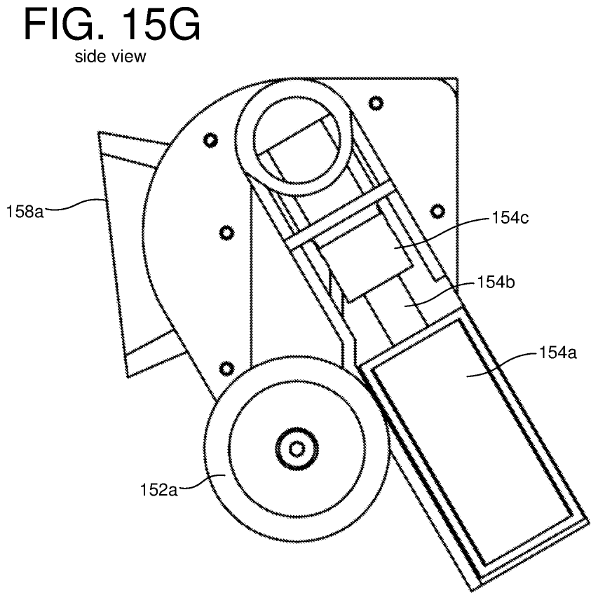

FIGS. 15A-15G illustrate another exemplary hinge mount 150 comprising a body 156 configured to mount to a flight helmet (e.g., through a bracket like that depicted in FIG. 12A), a pivot 158 with a portion 158a configured to mount a visor, an automated actuator 154 configured to selectively release the pivot 158 for rotational movement, and a manual actuator 152 configured to selectively release the pivot 158 for rotational movement. The pivot 158 is installed in the body 156 such that it may rotate with respect to the body as depicted with the dashed arrow in FIG. 15A.

Rotation of the pivot 158 is controlled by: (1) a torsion spring 158c installed such as to provide a spring force to rotate the pivot 158 up (to cause an attached visor to raise up into a position where it does not impede the pilot's vision); (2) a dog 155 configured to engage a notch in a notched surface 158b of the pivot 158 so as to resist the force provided by the torsion spring 158c and thereby lock the visor in position; (3) the automated actuator 154 configured to automatically move the dog 155 into the unlocked position and thereby allow the pivot 158 to rotate up due to the torque provided by the torsion spring 158c; and (4) the manual actuator 152 configured to allow the pilot to manually move the dog 155 into the unlocked position and thereby allow the pivot 158 to rotate up due to the torque provided by the torsion spring 158c. (A portion of the torsion spring 158c is shown in broken lines in FIG. 15B to denote that it is shown through the surface of the pivot 158.)

The dog 155 and the notched surface 158b are configured such that the pivot 158—and any attached visor—may be rotated down without moving the dog 155 into the unlocked position but may not be rotated up without moving the dog 155 into the unlocked position. A sufficient downward-rotation force on the pivot 158 causes a first surface on a notch of the notched surface 158b′ to engage a first surface of the dog 155′. These first surfaces 158b′, 155′ are angled such that the downward-rotation force on the pivot 158 causes an axial force on the dog 155 sufficient to overcome an oppositely directed axial force due to the dog spring 155b pushing the dog 155 toward the notched surface 158b. Thus, the downward-rotation force causes the dog 155 to move axially away from the pivot 158, as shown by the dashed arrow in FIG. 15B, compressing the dog spring 155b. The torsion spring 158c, dog spring 155b, dog 155, and notches of the notched surface 158b are configured such that a pilot may rotate the pivot 158—and thus move the visor into a down position—with minimal effort. But the weight of the visor alone will not cause the visor to rotate downward. An upward-rotation force on the pivot 158 causes a second surface on a notch of the notched surface 158b″ to engage a second surface of the dog 155″. But these second surfaces 158b″, 155″ are angled differently than the first surfaces 158b′, 155′ and the upward-rotation force on the pivot 158 is not translated into an axial force on the dog 157 sufficient to overcome the force due to the dog spring 155b. Thus, the dog 155 prevents upward rotation of the pivot 158 while allowing downward rotation of the pivot.

The dog-control mechanism includes a dog coupler 155a, dog spring 155b, dog-spring cap 155c, a manual-actuator lever arm 152d, and an automated-actuator dog-spring-cap retainer 154c. These components are disposed within a housing of the hinge mount 150. (Components of the mechanism for controlling the dog 155 are shown in broken lines in FIG. 15B to denote that the components are shown through a surface.) The pilot may engage the manual actuator 152 to cause the manual-actuator lever arm 152d to move the dog coupler 155a and thereby withdraw the dog 155 from the notched surface 158b, compressing the dog-spring 152d and allowing the torsion spring 158c to rotate the pivot 158 up (along with any attached visor). On a predetermined condition (e.g., information from a flight-safety sensor indicating an unsafe condition), the automated actuator 154 moves the dog-spring-cap retainer 154c away from the dog-spring cap 155c, allowing the dog-spring-cap retainer 154c to move away from the dog 155 and thereby removing the spring force otherwise provided by the dog spring 155b to push the dog 155 into a notch of the notched surface 158b of the pivot 158. This allows the torsion spring 158c to rotate the pivot 158 up and move the visor out of the pilot's line of sight.

Operation of the manual actuator 152 and the automatic actuator 154 can be better understood with reference to FIGS. 15E-15G. (Broken lines denote components viewed through a surface in the figures.) The manual actuator 152 includes a push button 152a, a push-button spring 152b, a push-button shaft 152c, a lever 152d, and a lever-pivot mount 152e. The lever 152d is: connected to the dog coupler 155a at one end of the lever 152d (the top end in the FIG. 15E), mounted to the hinge-mount housing 156 via the pivot mount 152d at a point between the two ends of the lever 152d, and positioned such that the other end of the lever 152d (the bottom end in the FIG. 15E) is next to the terminal end push-button shaft 152b (the end away from the push button 152a). The push-button spring 152c is disposed between a surface of the hinge-mount housing 156 and the push button 152a such that the spring 152c exerts a force on the push button 152a away from the housing. This force moves the push-button shaft 152c away from the bottom end of the lever 152d which allows the dog spring 155b to push the dog 155 into a notch of the notched surface 158b. The pilot may push on the push button 152a to overcome the force of the push-button spring 152c and cause the push-button shaft 152c to push against the bottom end of the lever 152d. This causes the bottom end of the lever 152d to move toward the pivot 158 and, because of the lever's pivot mount 152e, causes the top end the lever 152 to move away from the pivot 158. Because the top end of the lever 152d is connected to the dog 155 via the dog coupler 155a, pushing on the push button 152a moves the dog 155 away from the pivot's notched surface 158b. This allows the force from the torsion spring 158c to rotate the pivot 158.

The automated actuator 154 includes a solenoid 152a, a solenoid shaft 154b, and a dog-spring-cap retainer 154c (the solenoid 154a is not shown in FIG. 15E for sake of clarity). The solenoid shaft 154b is attached to the dog-spring-cap retainer 154c at one end (the top end in FIG. 15E) and to the solenoid 152a at the other end (the bottom end in FIG. 15E). The default position of the solenoid shaft 154b is the extended position in which the dog-spring-cap retainer 154c is positioned to retain the dog-spring cap 155c enabling the dog spring 155b to force the dog 155 into one of the notches of on the notched surface 158b. The solenoid 154a may be activated to retract the shaft 154b and thereby cause the dog-spring-cap retainer 154c to move away (down, in FIG. 15E) from the dog-spring cap 155c allowing the dog-spring cap 155c to move away from the pivot 158 and reducing the force from the dog spring 155b on the dog 155. This allows the force from the torsion spring 158c to rotate the pivot 158. (Potential motions of the various components are depicted in FIG. 15F with dashed arrows.)

A power supply may be electrically connected to electrooptic material on a visor mounted to the pivot 158 (via mounting portion 158a) through, for example, a wiring harness including wires directly connected to the electrooptic material or a copper-clad board and pin assembly as described for the exemplary embodiment depicted in FIG. 14.

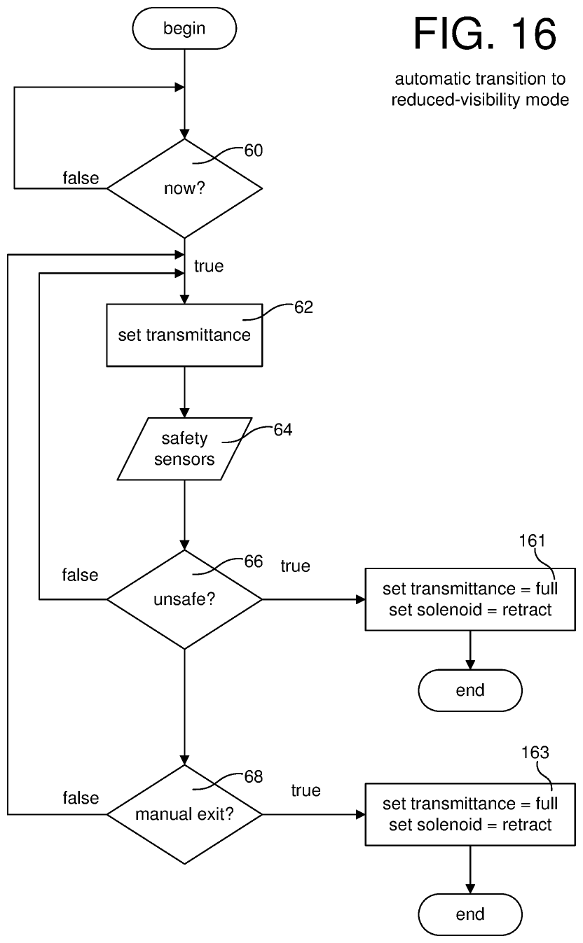

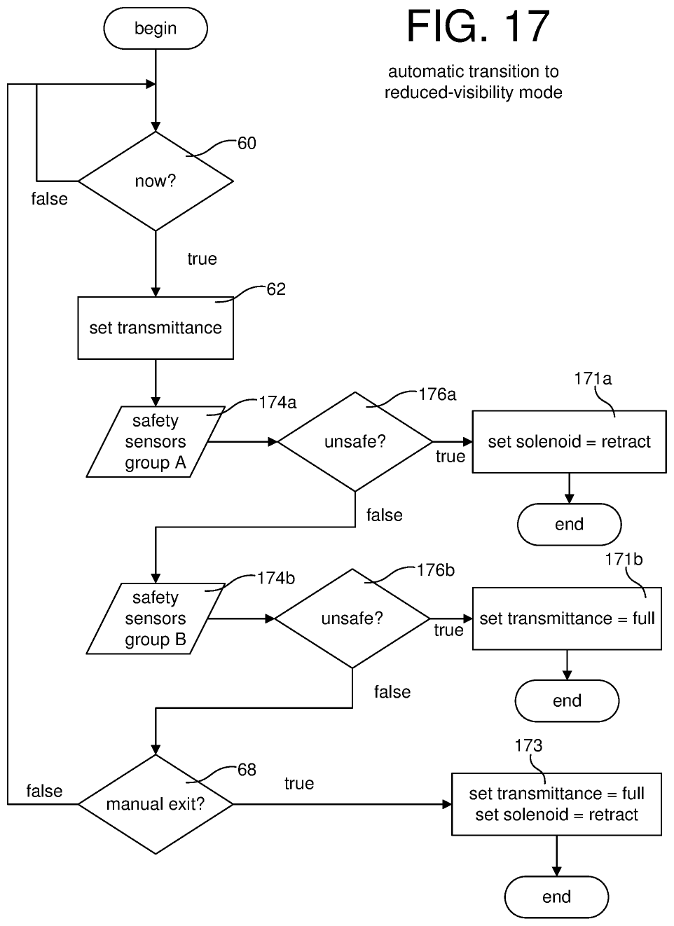

Pilot training using a vision-limiting device configured to physically move the electrooptic material out of the path of the pilot's vision on a predetermined condition is similar to the training flow shown in FIGS. 4-7. When a safety sensor indicates an unsafe condition, the electrooptic material may be automatically moved. For example, with a device that incorporates the exemplary hinge mount 150 depicted FIGS. 15A-15G, power may be provided to the solenoid 154a if a safety sensor provides a value outside of a predetermined “safe” range (as described above). This will cause the solenoid shaft 154b to retract and the electrooptic material (included on or in the visor) to move out of the pilot's line of sight. The may be used instead of setting the electrooptic material to full transmittance or in addition to setting the electrooptic material to full transmittance. For example, the exemplary data flow depicted in FIG. 16 is a modified version of the flow depicted in FIG. 6. On an unsafe condition 66 or manual exit 68, the transmittance is set to full and the visor is moved 161, 163. The exemplary flow in FIG. 17 differs in that unsafe conditions of a first group of sensors 174a, 176a (e.g., those related to the pilot's physical condition, such as blood pressure) trigger visor rotation 171a while unsafe conditions of a second group of sensors 174b, 176b (e.g., those related to the aircraft's position, such as an accelerometer or altimeter) trigger clearing the electrooptic material 171b. In another example, a safety-sensor's “unsafe” state may first trigger clearing the electrooptic material and if the state does not revert to a “safe” state in a predetermined amount of time (e.g., five minutes), then visor rotation is triggered. In another example, two “unsafe” states may be defined for a sensor. The first (e.g., absolute value of pitch greater than 25 and less than 30 degrees) triggers clearing the electrooptic material and the second (e.g., absolute value of pitch greater than or equal to 30 degrees) triggers rotation the visor out of the pilot's line of sight. Thus, any of the previously described training modes may be modified to incorporate physical removal of the electrooptic material.

A hinge mount with automated visor control (e.g., the exemplary embodiment depicted in FIGS. 15A-15G) may be used for various applications involving helmet-mounted displays. For example, such a mount may be used to mount a synthetic-vision display or an enhanced-flight-vision display. These are displays that replace (synthetic vision) or augment (enhanced flight vision) the pilot's line-of-sight view with a computer-generated image based on sensor, stored, and other data. See., e.g., L. Kramer et al., Enhanced Flight Vision Systems and Synthetic Vision Systems for NextGen Approach and Landing Operations, NASA/TP-2013-218054, available at https://ntrs.nasa.gov/archive/nasa/casi.ntrs.nasa.gov/20140003882.pdf; L. Glaab et al., General Aviation Flight Test of Advanced Operations Enabled by Synthetic Vision, NASA/TP-2014-218279, available at https://ntrs.nasa.gov/archive/nasa/casi.ntrs.nasa.gov/20140010732.pdf; L. Prinzel, NASA Research Techniques for Future Aviation Systems: The Case of Synthetic and Enhanced Vision Systems, NF1676L-21258, available at https://ntrs.nasa.gov/archive/nasa/casi.ntrs.nasa.gov/20160007097.pdf. A control system monitoring flight sensors (as described above) or the display generator determines if the display is functioning properly for the pilot. If the display is not functioning at all or if it is impeding rather than aiding the pilot, the control can engage the automated actuator and thereby remove the display from the pilot's line of sight.

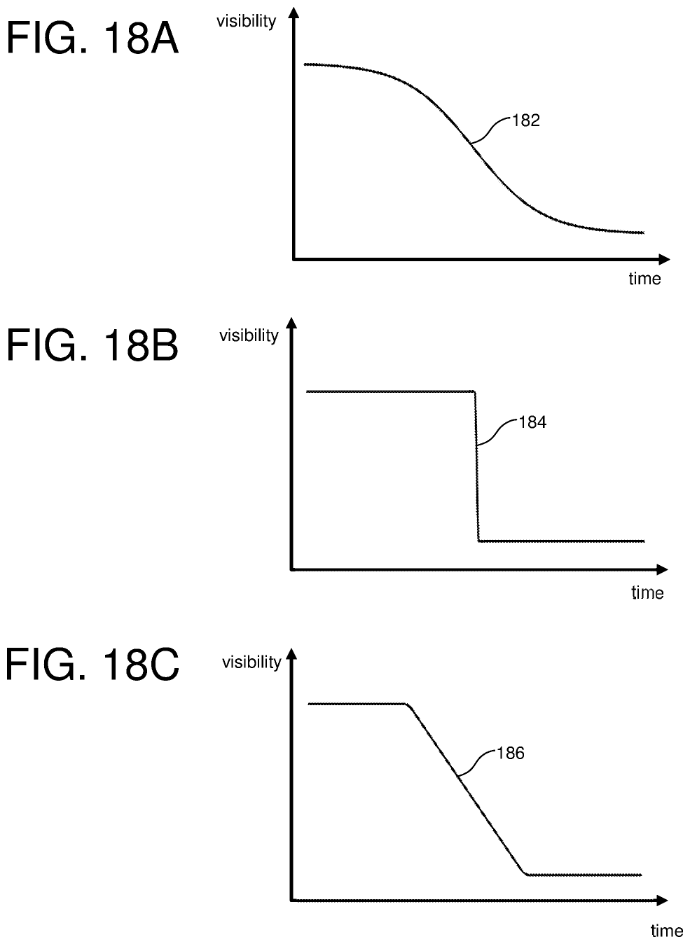

As described above, reduced-visibility conditions may be simulated using a profile of visibility settings versus time. Such a profile may be predetermined and stored in computer memory for access during the training event or it may be dynamically generated during the training event. A particular reduced-visibility profile may be predetermined to simulate a particular reduced-visibility scenario. Some exemplary scenarios are depicted in FIGS. 18A-18C. During the training event, the simulated visibility (e.g., transmittance setting of an electrooptic material or display setting of a synthesized or augmented display) is varied with time according to a profile 182, 184, 186. Safety sensors may be monitored during the event to override the scenario by increasing the visibility setting (e.g., changing the voltage provided to an electrooptic material or the display setting of a synthesized or augmented display) or by moving the material/display away from the pilot's line of sight by, e.g., engaging an actuator such as an electromagnetic brake to enable movement of a visor. The visibility setting in these figures depends directly on time (e.g., the time from the start of the training event, time since initiation of the scenario, and time of day). The way in which the visibility varies with time may be predetermined to simulate a hypothetical condition (e.g., flying into a fog bank or smoke or landing on snow or sand) or the time variance may be predetermined to simulate the measured conditions of an actual accident or other incident of reduced visibility. The time variance may be tailored for an individual pilot. For example, a profile may be repeated for a pilot who failed the last attempt at a profile, a more-aggressive profile may be used for a pilot who succeeded in a less-aggressive profile, or a profile may be generated to simulate expected conditions for a particular mission.

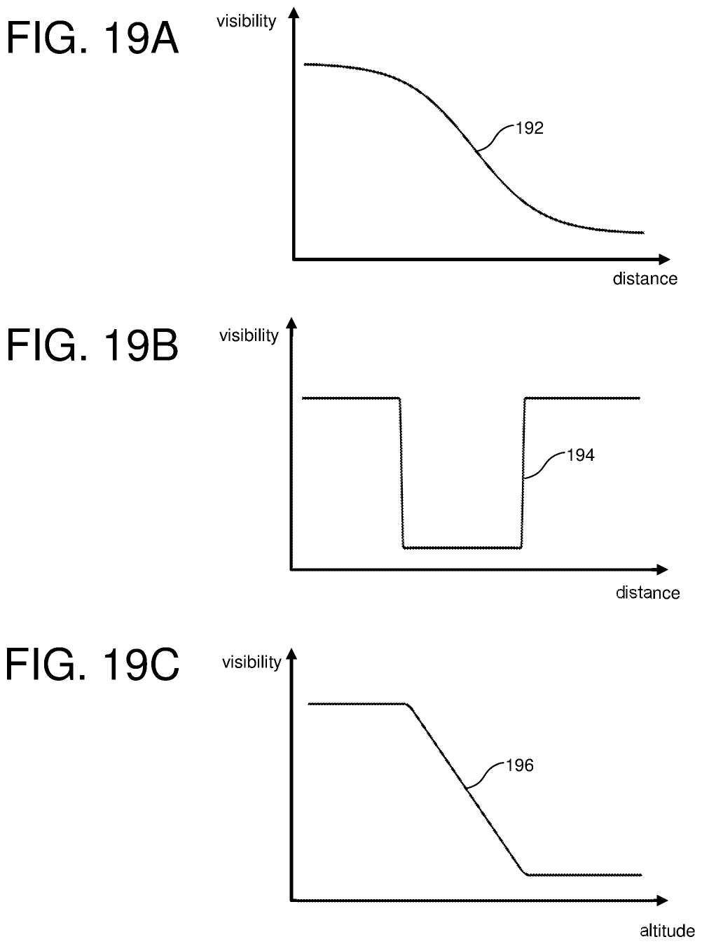

Training scenarios may be generated with visibility profiles based on parameters other than time. For example, the visibility setting may directly depend on the position of the aircraft (e.g., a distance from a reference point or another aircraft). FIGS. 19A and 19B depict exemplary visibility-versus-distance profiles 192, 194. Similarly, the visibility setting may directly depend on the altitude of the aircraft. FIG. 19C depicts an exemplary visibility-versus-altitude profile 196. The visibility setting may likewise depend on other position parameters such as heading, rate of change of altitude, velocity, acceleration, attitude, and change of attitude of the aircraft. Safety sensors may be used to override the scenario during a training event. The way in which the visibility varies with aircraft position can be predetermined to simulate a hypothetical condition or to simulate the measured conditions of an actual accident. Because these scenarios depend on the aircraft position, which is not strictly deterministic and depends on actual flight conditions, the visibility conditions are dynamically generated.

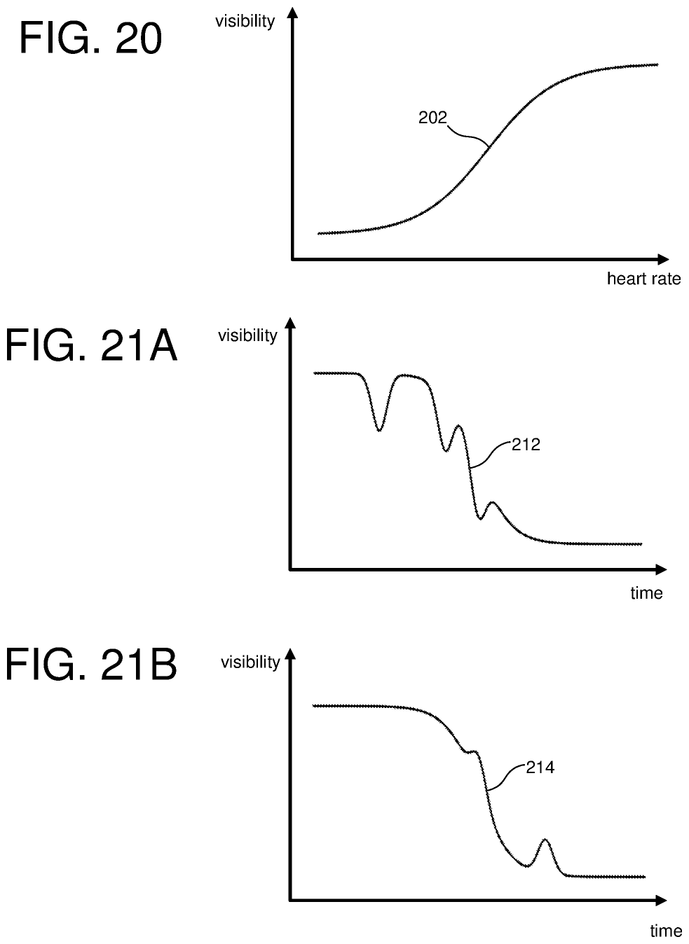

Training scenarios may also be generated using physiological data of the pilot in training. For example, the visibility setting may directly depend on one or more of the following: heart rate, blood pressure, body temperature, muscle tension, eye movements, head movements, sweat level, blood-oxygen level, respiration rate, or pupil dilation. As depicted in FIG. 20, the visibility profile 202 may be, for example, linked to the pilot's heart rate to track whether the training event is inducing spatial disorientation in the pilot as desired. If the pilot's heart rate does not increase with a particular visibility setting or profile, then the visibility may be further or more quickly decreased in an attempt to raise the pilot's heart rate (which may indicate spatial disorientation). If the pilot's heart rate is too rapid or is rising too quickly, then the visibility may be increased, or the rate of decrease slowed, in order to maintain a desired level of spatial disorientation. In this way, the visibility setting may be dynamically changed based on one or more of the pilot's physiological parameters to reach and maintain a level of spatial disorientation to better train the pilot to handle sudden-onset reduced visibility events. Safety sensors may be used to override the scenario during a training event.

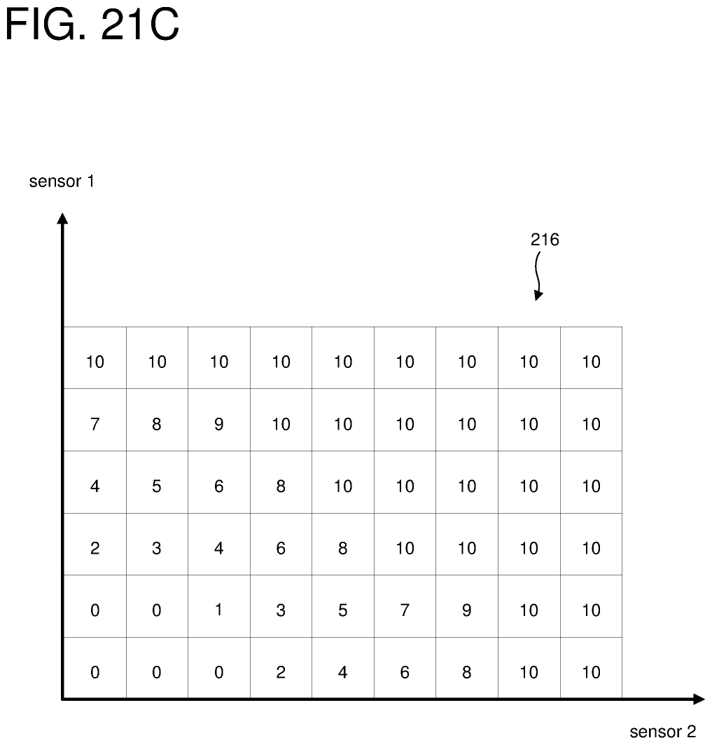

Training scenarios may be generated using a combination the above-described parameters. For example, a predetermined visibility-versus-time profile may be perturbed based on aircraft position, pilot condition, visibility-versus-time profile snippets, or training-pilot manual input. The profile 212 depicted in FIG. 21A may correspond to, e.g., a predetermined visibility profile that gradually decreases from high visibility to low visibility as perturbed by random, preselected, or manually induced periods of decreasing/increasing visibility designed to simulate, e.g., wafting smoke or fog. Similarly, the profile 214 in FIG. 21B may correspond to, e.g., a predetermined visibility profile that gradually decreases from high visibility to low visibility as perturbed by dynamic visibility adjustments based on pilot eye movements. The exemplary profile in FIG. 21C is presented in an array 216 in which the visibility setting is represented as a number between 0 and 10, with 0 being the lowest visibility and the 10 being the highest visibility setting. In this example, the visibility profile may represent an absolute setting or a perturbation of another visibility setting. Visibility profiles may be stored in memory, e.g., in variables or data structures or as a representative function used to calculate the visibility setting based on one or more parameters.

Examples of implementations of a visibility profile can be understood with reference to FIG. 2A. A visibility-versus-time profile is stored in memory 26 as a sequence of visibility values (e.g., in an array, table, matrix, or other data structure). The power supply 20 (in this case, a programmable power supply) reads the profile stored in memory as a sequence of inputs and outputs a sequence of electronic signals (e.g., current or voltage amplitude) that correspond to the visibility states in the electrooptic material 22a. (The reading/outputting may be, e.g., on a value-by-value basis or in blocks of values.) A sensor, e.g., barometer 27 or accelerometer 28, may be monitored and used to override or perturb the electronic signals associated with the visibility-versus-time profile. For example, if the accelerometer 28 reading indicates an unsafe flying condition, the power supply 20 may override the predetermined visibility-versus-time values with a maximum transmittance state. In another example, the barometer 27 reading may override the visibility-versus-time values such that the visibility-versus-time profile is not implemented until the aircraft reaches a predetermined minimum altitude and is overridden with a maximum transmittance state if the aircraft exceeds a predetermined maximum altitude. In another example, the accelerometer 28 reading may indicate an aircraft velocity or acceleration that speeds (or slows) progression along the visibility-versus-time profile: e.g., increasing the rate sequencing through the profile so as to change the transmittance state of the electrooptic material 22a every second instead of every 2 seconds. In another example, the barometer 27 reading may be used to scale the visibility settings of the visibility-versus-time profile (e.g., increasing the visibility by 5% for every 500 feet of altitude above a predetermined altitude threshold).

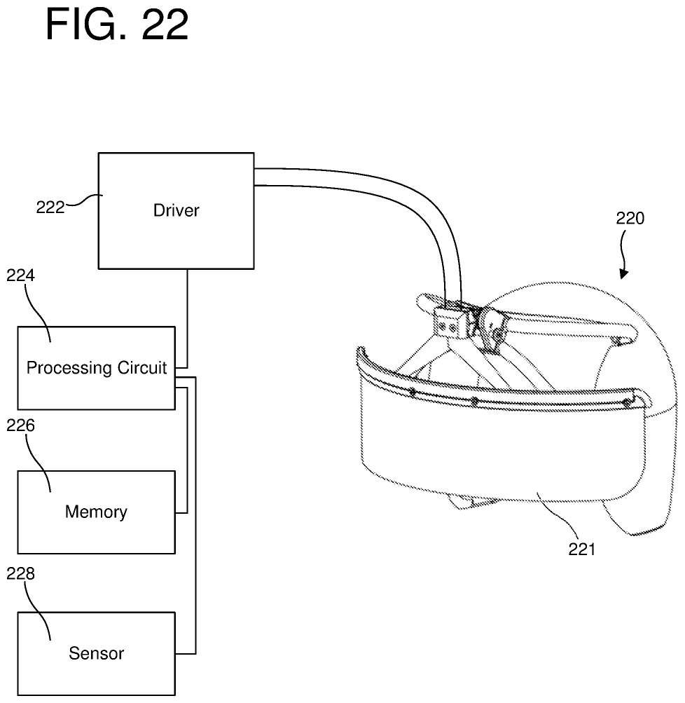

Examples of implementations of a visibility profile can also be understood with reference to FIG. 22. A visibility-versus-time profile is loaded into memory 226 as a sequence of visibility values (e.g., in an array, table, matrix, or other data structure). The profile may represent, e.g., a hypothetical reduced-visibility event, a reduced-visibility event previously presented to the pilot in a training session, or a reduced-visibility event that resulted in an aircraft accident (reconstructed from, e.g., aircraft or meteorological data). The processing circuit 224 (e.g., a microprocessor, microcontroller, ASIC, PLC) reads the profile from memory 226, and generates a sequence of electronic signals to establish optical states of an optical material 221 that correspond to the visibility values (e.g., by providing a bit pattern to drive a display, providing a value to drive a DAC or power supply across an electrooptic material, or by controlling an amplifier or potentiometer/rheostat to modify a current or voltage to provide to an electrooptic material). The processing circuit 224 may monitor a sensor 228 and override or perturb the electronic signals based on the sensor 228 reading. For example, the sensor 228 may be a physiological sensor such as a heart-rate sensor or blood-pressure sensor. The processing circuit 224 may determine whether the sensor 228 reading indicates that the pilot is in: (1) a relaxed state (indicating no or insufficient spatial disorientation for training purposes), (2) a moderately stressed state (indicating sufficient spatial disorientation for training purposes), or (3) an overly stressed state (indicating excessive spatial disorientation and unsafe training conditions). If the pilot is too relaxed, the circuit 224 will decrease the visibility state or increase the rate of decrease of sequential visibility states to induce (more) spatial disorientation. If the pilot is too stressed, the circuit 224 will increase the visibility state, increase the rate of increase in sequential visibility states, or decrease the rate of decrease in sequential visibility states to reduce spatial disorientation. If moderate increases in the visibility states do not sufficiently reduce the stress of the pilot, the circuit 224 will set the optical material 221 to its maximum visibility state or generate a signal to move the optical material 221 (e.g., by rotating the visor on a flight helmet 220). The sensor readings that correspond to the stress levels of the pilot may be predetermined based on statistical data from stress-tests (such as previous training sessions or simulators) of one or more samples of pilots or based on individual data from stress-tests of the pilot in training. In FIG. 22, the processing circuit may connect to the optical material through a display driver 222 for an enhanced-flight-vision or a synthetic-vision display or through a controllable power supply for electrooptic material. Though depicted separately, the driver/power supply, processing circuit, memory, and sensor are not necessarily separate components.

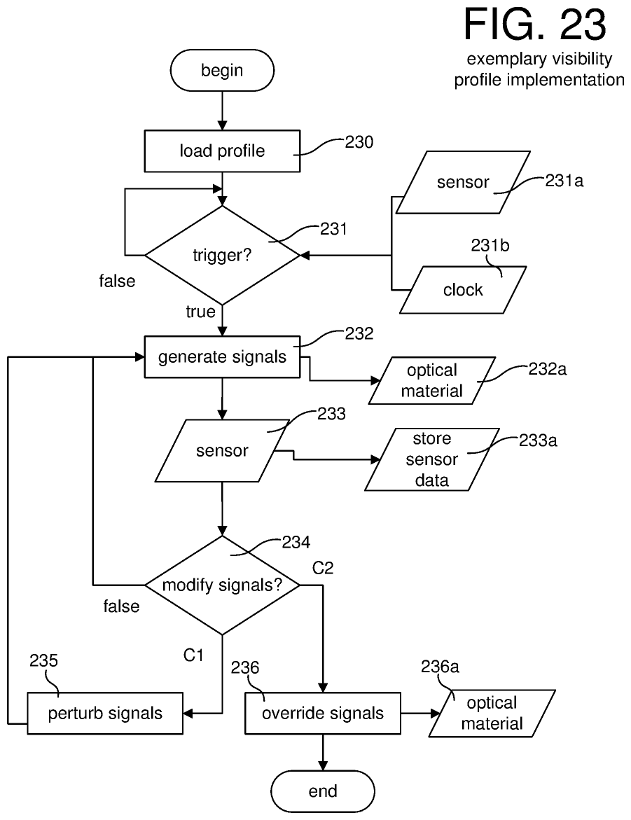

An exemplary visibility-profile-implementation flow is depicted in FIG. 23. A visibility profile is loaded into memory 230. The system determines 231 whether to begin the training event based on, e.g., sensor data 231a (reflecting aircraft, pilot, or environmental flight parameters) or clock data 231b (reflecting, e.g., time of day or relative timing). (The training event may also be manually triggered.) If not, the system idles and periodically checks whether to trigger 231 the training event. If so, visibility signals are generated 232 based on the profile and sent 232a to the optical material (electrooptic material, enhanced-flight-vision, synthetic-vision display) to establish a visibility condition. One or more sensors are read 233 during the training event. This may be the same sensor(s) as used in the trigger step, or it may be a different sensor(s). The sensor data may be stored 233a to use, for example, for post-training analyses or to generate profiles for subsequent use. Based on the sensor data, the system determines 234 whether to modify the visibility signals. If not, then the system continues to generate the sequence of visibility signals to set the optical state of the optical material. If modification is warranted based on the sensor data, the visibility signals are perturbed 235 or overridden 236, depending on the sensor data. For example, a first condition (C1) may be predefined as one or more ranges of values for one or more sensors in which the training event is predetermined safe to continue but in which the visibility is increased or decreased or changed at a faster or slower rate over that established by the profile. A second condition (C2) may be predefined as a range of values for one or more ranges of values for one or more sensors in which the training event is predetermined to be unsafe to continue. If the first condition (C1) is satisfied, then the signals are perturbed according to a predetermined function (e.g., the superposition of a second visibility profile, the application of a scaling factor, or the application of an offset factor). If the second condition (C2) is satisfied, then the signals are overridden to set 236a the optical material to its maximum visibility state or to move the material away from the pilot's line of sight and the training session ends. One may define multiple override conditions. For example, one condition to set the optical material at its maximum state and suspend the training event until the safety sensors indicate that it is safe to resume or restart the training event and another condition to move the optical material and end the training event, requiring manual intervention to restart. The order of the flow is not necessarily important for all steps. For example, the profile may be loaded after the trigger event or it may be simultaneously loaded on a value-by-value basis with the step of generating the signal.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A method for training a pilot to operate an aircraft in sudden-onset reduced-visibility conditions, the method comprising:
(a) providing an optical material having an electrically controllable optical state;
(b) providing a sequence of visibility values, each visibility value corresponding to an optical state of the optical material;
(c) generating a sequence of electrical signals based on the sequence of visibility values;
(d) sequentially providing the electrical signals of the sequence of electrical signals to the optical material;
(e) collecting information from at least one flight-safety sensor; and
(f) selectively modifying the electrical signals sequentially provided to the optical material using the information collected from the at least one flight-safety sensor.

2. The method of claim 1 wherein the step of providing a sequence of visibility values includes providing a series of values in computer memory.

3. The method of claim 2 wherein the series of values in computer memory corresponds to a previous instance of a training method with the pilot.

4. The method of claim 2 wherein the series of values in computer memory corresponds to data from an incident.

5. The method of claim 1 wherein the step of providing a sequence of visibility values includes providing a series of values based on information from a flight-safety sensor.

6. The method of claim 5 wherein the flight-safety sensor is a different sensor than the at least one flight-safety sensor of the collecting information step.

7. The method of claim 5 wherein the flight-safety sensor includes at least one of the group consisting of a physiological sensor, a GPS monitor, an accelerometer, a barometer, an orientation sensor, and an Automatic Dependent Surveillance-Broadcast (ADS-B) system.

8. The method of claim 1 further comprising modifying the position of the optical material using information collected from at least one flight-safety sensor.

9. The method of claim 8 wherein the information used in the step of modifying the position of the optical material is different from the information used in the step of modifying the electrical signals sequentially provided to the vision-limiting device.

10. The method of claim 1 wherein the optical material is one of the group consisting of a synthetic-vision display, an enhanced-flight-vision display, and an electrooptic material.

11. The method of claim 1 wherein:
(a) the step of collecting information from at least one flight-safety sensor includes collecting information from at least one physiological sensor, and
(b) the step of modifying the electrical signals sequentially provided to the optical material using the information collected from the at least one flight-safety sensor includes at least one of the group consisting of determining an electrical signal corresponding to a lower-visibility optical state if the physiological sensor indicates a lack of spatial disorientation in the pilot and determining an electrical signal corresponding to a higher-visibility optical state if the physiological sensor indicates an unsafe level of spatial disorientation in the pilot.

12. A system for training a pilot to operate an aircraft in sudden-onset reduced-visibility conditions using an integrated or non-integrated flight-safety sensor, the system comprising:
(a) an optical material having an electrically controllable optical state;
(b) a computer memory; and
(c) a processing circuit connected to the optical material, the flight-safety sensor, and the computer memory, wherein the processing circuit is configured to perform an algorithm comprising:
(i) collect information from the flight-safety sensor,
(ii) retrieve values from the computer memory,
(iii) generate, based on the values retrieved from computer memory, electrical signals that correspond to optical states of the optical material,
(iv) generate, based on the collected information, electrical signals that correspond to optical states of the optical material, and
(v) provide to the optical material at least one of the group consisting of the electrical signals generated based on the retrieved values and the electrical signals generated based on the collected information.

13. The system of claim 12 wherein the flight-safety sensor is a physiological sensor.

14. The system of claim 12 wherein the flight-safety sensor is an aircraft-position sensor.

15. The system of claim 12 wherein the computer memory stores at least one of the group consisting of values corresponding to a previous training event, values corresponding to an incident, and values corresponding to a hypothetical reduced-visibility scenario.

16. The system of claim 13 wherein the generate-based-on-the-collected-information step of the processing circuit algorithm includes determining an electrical signal corresponding to a lower-visibility optical state if the physiological sensor indicates a lack of spatial disorientation in the pilot.

17. The system of claim 12 wherein the optical material is one of the group consisting of a synthetic-vision display, an enhanced-flight-vision display, and an electrooptic material.

18. The system of claim 12 further comprising an Automatic Dependent Surveillance-Broadcast (ADS-B) system, the Automatic Dependent Surveillance-Broadcast (ADS-B) system configured to provide a signal indicative of a status of the aircraft.

19. A system for training a pilot to operate an aircraft in sudden-onset reduced-visibility conditions, the system comprising:
(a) an optical material having an electrically controllable optical state;
(b) a first flight-safety sensor;
(c) a second flight-safety sensor; and
(d) a processing circuit connected to the optical material, the first flight-safety sensor, and the second flight-safety sensor, wherein the processing circuit is configured to perform an algorithm comprising:
(i) collect information from the first flight-safety sensor,
(ii) collect information from the second flight-safety sensor,
(iii) generate, based on the information collected from the first flight-safety sensor and the information collected from the second flight-safety sensor, electrical signals that correspond to optical states of the optical material, and
(iv) provide to the optical material the electrical signals.

20. The system of claim 19 wherein:
(a) the first flight-safety sensor is a speed sensor, and
(b) the second flight-safety sensor is an altitude sensor.

21. A non-transitory computer readable medium comprising computer-executable instructions to configure a processing circuit to perform an algorithm comprising:
(i) collect information from a flight-safety sensor,
(ii) retrieve values from computer memory,
(iii) generate, based on the values retrieved from computer memory, electrical signals that correspond to optical states of an optical material,
(iv) generate, based on the collected information, electrical signals that correspond to optical states of the optical material, and
(v) provide to the optical material at least one of the group consisting of the electrical signals generated based on the retrieved values and the electrical signals generated based on the collected information.
